(19) United States
(12) Patent Application Publication
(10) Pub. No.: US 2002/0107796 A1
(43) Pub. Date: Aug. 8, 2002

(54) Online shopping settlement method and system, and online shopping settlement program

(76) Inventor: Masaki Nakai, Tokyo (JP)

Correspondence Address: DICKSTEIN SHAPIRO MORIN & OSHINSKY LLP, Steven I. Weisburd, 41st Floor, 1177 Avenue of the Americas, New York, NY, 10036-2714, US

(21) Appl. No.: 10/067,428

(22) Filed: Feb. 7, 2002

(30) Foreign Application Priority Data
Feb. 5, 2001 (JP) 027919/2001

(51) Int. Cl. G06F 17/60

(52) U.S. Cl. 705/40

(57) ABSTRACT

Both order slip 5 forwarded from user terminal 1 via network 3 like the Internet for example to Web server 2 providing online shopping services and order confirmation slip 6 forwarded from Web server 2 to user terminal 1 to confirm receipt of order slip 5, are monitored by settlement system 4 of a communication common carrier providing communication services to user terminal 1 which carrier acts in substitute for collecting communication charges or are detected through being relayed. Settlement system 4 collects payment (8) from user terminal 11 by invoicing user terminal 11 for online shopping charges only in respect of transactions for which the requisite pair of order slip 5 and order confirmation slip 6 are prepared together with communication charges when invoicing user terminal 11 for communication charges and pays the appropriate amount therefrom to Web server 2 (7).

### BACKGROUND OF THE INVENTION

1. Field of the Invention

This invention relates to an online shopping settlement system, and more specifically, an online shopping settlement system wherein a communication common carrier collects payment that should be paid to an online shop on the Web, a “Web shop,” by a user.

2. Description of Related Art

The rapid diffusion of the Internet in recent times has made it possible for people to shop online easily through accessing a Web shop via a personal computer for example, installed in a home. When a user purchases from a Web shop the cost of the purchase must be paid and credit card payment is mainly used as the method for settlement. In this situation the user informs the Web shop of his credit card number when he purchases the product, the Web shop then requests payment of the charges from the appropriate credit card company and the credit card company deducts the money for the charges from the bank account of the user.

However, because the credit card settlement method involves credit card information flowing over a public network there is a risk of such information being intercepted by a person of malicious intent. Further, there may be problems such as personal credit card information being improperly obtained by a malicious individual intruding into a Web site, and such issues do in fact present a problem for society. Again, there are many users who feel reluctant about providing their own credit card number to a well-known Web site. For these reasons, a new method of settlement for use instead of a credit card is desirable.

Conventional methods proposed as methods of settlement without employing a credit card will now be described.

One is the method described in JP H09-153964 A, organized such that a telephone call requesting the sending of an invoice for provision of information or services to a user by a service provider via the Internet is made to a 900 number associated with the service provider for that purpose. Hereafter, this method is referred to as the “first conventional technology”.

Another method is the one described in JP H09-282367 A. With this method, a member applies to purchase a product from a member store via a network using his own individual ID number and a purchasing agency service provider that receives notification from the member store about the application issues notice by e-mail to that member store authorizing the sale, after confirming by e-mail, that that member does intend to make the purchase. The member store then provides the product. The financial institution receives data on the substitution payment from the purchasing agency service provider and in addition to facilitating the substitution payment into the bank account of the member store, transfers money required for the purchase price from a bank account of the member into a bank account of the purchasing agency service provider based on data received from the purchasing agency services provider. Hereafter this method is referred to as the “second conventional technology”.

Yet another method is the technology described in JP H11-313058 A which is a settlement method wherein a communication common carrier facilitates settlement between users. A user sends a payment transfer request e-mail recording the ID of the one receiving transfer of payment and the corresponding mail address, details of the amount to be sent, the ID of the payment transfer sender and the corresponding e-mail address to a payment collections center of the communication common carrier via a network. When issuing invoices for communication charges, the payment collections center invoices the user who is the payment sender for the amount to be sent in addition to communication charges and invoices the user that is the payment receiver for an amount minus the amount sent. Hereafter, this method is referred to as the “third conventional technology”.

Different types of settlement method not requiring use of a credit card are as described above, however a problem with all of them is that they involve complex procedures. The first conventional technology for example requires that the user performs special procedures to make a telephone call requesting the sending of an invoice. For the second conventional technology, in addition to procedures required for registering each user with a purchasing agency service provider in advance, the user and member store must each exchange emails with the purchasing agency service provider each time a product is purchased. When the third conventional technology is applied for settlement between a user and a Web shop, the user must send a payment transfer request each time he purchases a product making the Web shop the payment receiver.

### SUMMARY OF THE INVENTION

The object of the present invention is to provide a new online shopping settlement method and system therefor that enables users to enjoy online shopping using only simple procedures and not requiring the use of a credit card.

An online shopping settlement method of the present invention involves both an order slip sent from a user terminal to a Web server providing online shopping services and an order confirmation slip for confirming receipt of that order slip sent from that Web server to that user terminal, being detected by a communication common carrier that provides communication service to that user terminal and collects the price therefor as communication charges, acting as a substitute, in respect of transactions for which the requisite pair of order slip and order confirmation slip are prepared, to collect charges that should be paid by that user terminal to that Web server.

More specifically, a first online shopping settlement method according to the present invention is a settlement method for an online shopping system including a user terminal, an Internet service provider connected to that user terminal via a network of a communication common carrier providing communication services to that user terminal and a Web server connected to that Internet service provider via the Internet which Web server provides online shopping services for that user terminal. This online shopping settlement method includes also (a) a step for detecting an order slip sent from the user terminal to the Web server and an order confirmation slip for confirming receipt of that order slip sent from that Web server to that user terminal, (b) a step for recording the order slip and order confirmation slip thus detected and (c) a step wherein the communication common carrier that provides a communication service to that user terminal and collects the price therefor as communication charges, acts as a substitute in respect of a transaction for which the requisite pair of order slip and order confirmation slip are prepared and which transaction is recorded, to collect charges that should be paid by that user terminal to that Web server.

Further, a second online shopping settlement method according to the present invention is an online shopping settlement method according to the first online shopping settlement method which uses a port number for online shopping especially set for the order slip and order confirmation slip for sending and receiving the order slip and order confirmation slip between the user terminal and the Web server and which, at step (a), detects those packets among packets going out from the Internet service provider to the Internet which have an online shopping port number as being an order slip and detects those packets among packets coming into the Internet service provider from the Internet which have an online shopping port number as being an order confirmation slip.

A third online shopping settlement method according to the present invention is an online shopping settlement method according to the first online shopping settlement method which relays the order slip and the order confirmation slip using a relay point established in advance for facilitating the sending and receiving of those slips between the user terminal and Web server and which, at step (a), detects the order slip and order confirmation slip through that relay point.

A fourth online shopping settlement method according to the present invention is an online shopping settlement method according to either the second or third online shopping settlement methods which, at step (b), uses a Web server IP table holding a list of IP addresses of Web servers for which charges are collected in substitute and does not record an order slip among those order slips detected at step (a) for which the IP address of the Web server that is the destination is not registered in the Web server IP table and does not record an order confirmation slip amongst those order confirmation slips detected at step (a) for which the IP address of the Web server that is the sender is not registered in the Web server IP table.

A fifth online shopping settlement method according to the present invention is an online shopping settlement method according to either the second or third online shopping settlement methods wherein is also included a step (d) that establishes an account-subscriber table holding a list of the relationship between the account name allocated to the user terminal by the Internet service provider and the subscriber line number of the user terminal, that accesses the account-subscriber table using the account name of the user terminal that connected to the Internet service provider to retrieve the appropriate subscriber line number and then certifies the user terminal that connected to the Internet service provider through checking conditions of that subscriber line.

A sixth online shopping settlement method according to the present invention is an online shopping settlement method according to the fifth method that, while the user terminal is connected to the Internet service provider, stores the relationship between an IP address allocated to the user terminal from the Internet service provider and the subscriber line number in an IP-subscriber table, and which at step (b), does not record an order slip from among those order slips detected at step (a) for which the subscriber line number corresponding to the source IP address is not registered in the IP-subscriber table, and does not record an order confirmation slip from among those order confirmation slips detected at step (a) for which the subscriber line number corresponding to the IP address of the user terminal that is the destination is not registered in the IP-subscriber table.

A seventh online shopping settlement method according to the present invention is an online shopping settlement method according to either the second or third online shopping settlement methods wherein is also included a step (d) that establishes an account-caller table holding a list of the relationship between the account name allocated to the user terminal by the Internet service provider and the calling telephone number of the user terminal, and certifies the user terminal connected to the Internet service provider through checking whether or not the combination of the account name of the user terminal connected to the Internet service provider and the calling telephone number is registered in the account-caller table.

An eighth online shopping settlement method according to the present invention is an online shopping settlement method according to the seventh online shopping settlement method that, while the user terminal is connected to the Internet service provider, stores the relationship between an IP address allocated to the user terminal from the Internet service provider and the calling telephone number in an IP-caller table, and which at step (b), does not record an order slip from among those order slips detected at step (a) for which the calling telephone number corresponding to the source IP address is not registered in the IP-caller table, and does not record an order confirmation slip from among those order confirmation slips detected at step (a) for which the calling telephone number corresponding to the IP address of the user terminal that is the destination is not registered in the IP-caller table.

A ninth online shopping settlement method according to the present invention is an online shopping settlement method according to any of the fourth, sixth or eighth online shopping settlement methods wherein if at step (b) an order slip is not recorded that order slip is not forwarded to the Web server and if an order confirmation slip is not recorded that order confirmation slip is not forwarded to the user terminal.

A tenth online shopping settlement method according to the present invention is an online shopping settlement method according to any of the fourth, sixth or eighth online shopping settlement methods wherein regardless of whether at step (b) an order slip is recorded or not recorded the order slip is forwarded to the Web server and regardless of whether at step (b) the order confirmation slip is recorded or not recorded the order confirmation slip is forwarded to the user terminal.

An eleventh online shopping settlement method according to the present invention is an online shopping settlement method according to either the second or third online shopping settlement methods that, at step (c) calculates the online shopping charges that should be collected from the user based on the order slip and order confirmation slip recorded at step (b) and requests payment therefor together with communication charges when invoicing the user terminal for communication charges.

A twelfth online shopping settlement method according to the present invention is an online shopping settlement method according to either the second or the third online shopping settlement methods that, at step (c) calculates the online shopping charges that should be paid to the Web server based on the order slip and order confirmation slip recorded at step (b) and pays those online shopping charges to the Web server.

Alternatively, an online shopping settlement system according to the present invention provides a means for collecting charges in substitute, which means provides an order slip monitoring means for detecting an order slip sent from a user terminal to a Web server providing online shopping services and detecting an order confirmation slip sent from the Web server to the user terminal for confirming receipt of the order slip, provides an order slip recording means for recording an order slip and order confirmation slip detected by the order slip monitoring means, which means is for use by a communication common carrier that provides a communication service to that user terminal and collects the price therefor as communication charges, while this means for collecting charges in substitute acts as a substitute, in respect of a transaction for which the requisite pair of order slip and order confirmation slip are prepared and recorded in the order slip recording means, to collect charges that should be paid by that user terminal to that Web server.

More specifically, the first online shopping settlement system according to the present invention is an online shopping system settlement system comprising a user terminal, an Internet service provider connected to that user terminal via a network of a communication common carrier providing communication services to that user terminal and a Web server connected to that Internet service provider via the Internet which server provides online shopping services to that user terminal, said settlement system providing: an order slip monitoring means for detecting an order slip sent from the user terminal to the Web server and detecting an order confirmation slip sent from the Web server to the user terminal for confirming receipt of the order slip; and an order slip recording means for recording the order slip and order confirmation slip detected by the order slip monitoring means; and a settlement means for collecting charges in substitute that is a means for use by the communication common carrier which means acts as a substitute in respect of a transaction for which the requisite pair of order slip and order confirmation slip are prepared and recorded in the order slip recording means, to collect charges that should be paid by that user terminal to that Web server.

Further, the second online shopping settlement system according to the present invention is an online shopping settlement system according to the first online shopping settlement system configured so as to use a port number for online shopping especially set for the order slip and order confirmation slip for sending and receiving the order slip and order confirmation slip between the user terminal and the Web server, wherein the order slip monitoring means provides a means for detecting those packets among packets going out from the Internet service provider to the Internet which have an online shopping port number as being an order slip and detecting those packets among packets coming into the Internet service provider from the Internet which have an online shopping port number as being an order confirmation slip.

The third online shopping settlement method according to the present invention is an online shopping settlement method according to the first online shopping settlement method configured so as to relay the order slip and the order confirmation slip using a relay point established in advance for facilitating the sending and receiving of those slips between the user terminal and Web server, and wherein the order slip monitoring means is configured so as to detect the order slip and order confirmation slip through that relay point.

The fourth online shopping settlement method according to the present invention is an online shopping settlement method according to either the second or third online shopping settlement methods wherein the order slip recording means provides a Web server IP table holding a list of IP addresses of Web servers for which charges are collected by a substitute, which means is configured so as not to record an order slip among those order slips detected by the order slip monitoring means for which the IP address of the Web server that is the destination is not registered in the Web server IP table and not to record an order confirmation slip amongst those order confirmation slips detected by the order slip monitoring means for which the source IP address is not registered in the Web server IP table.

The fifth online shopping settlement method according to the present invention is an online shopping settlement method according to either the second or third online shopping settlement methods which provides an account-subscriber table holding a list of the relationship between the account name allocated to the user terminal by the Internet service provider and the subscriber line number of the user terminal, and provides a subscriber certification means that receives from the Internet service provider the account name of the user terminal that connected to the Internet service provider, accesses the account-subscriber table and retrieves the appropriate subscriber line number and through checking the condition of that subscriber line, certifies the user terminal connected to the Internet service provider.

The sixth online shopping settlement method according to the present invention is an online shopping settlement method according to the fifth method wherein the subscriber certification means provides an IP-subscriber table for storing the relationship between an IP address allocated to the user terminal from the Internet service provider and the subscriber line number while the user terminal is connected to the Internet service provider, and wherein the order slip recording means is configured so as not to record an order slip from among those order slips detected by the order slip monitoring means for which the subscriber line number corresponding to the source IP address is not registered in the IP-subscriber table, and so as not to record an order confirmation slip from among those order confirmation slips detected by the order slip monitoring means for which the subscriber line number corresponding to the IP address of the user terminal that is the destination is not registered in the IP-subscriber table.

The seventh online shopping settlement method according to the present invention is an online shopping settlement method according to either the second or third online shopping settlement methods which provides an account-caller table holding a list of the relationship between the account name allocated to the user terminal by the Internet service provider and the calling telephone number of the user terminal, and provides a subscriber certification means that receives from the Internet service provider, the account name of the user terminal that connected to the Internet service provider and the calling telephone number, and through checking whether or not the combination of the account name of the user terminal connected to the Internet service provider and the calling telephone number is registered in the account-caller table, certifies the user terminal that connected to the Internet service provider.

The eighth online shopping settlement method according to the present invention is an online shopping settlement method according to the seventh online shopping settlement method wherein the subscriber certification means provides an IP-caller table that stores the relationship between the IP address allocated to the user terminal from the Internet service provider and the calling telephone number while the user terminal is connected to the Internet service provider, and wherein the order slip recording means is configured so as not to record an order slip from among those order slips detected by the order slip monitoring means for which the calling telephone number corresponding to the source IP address is not registered in the IP-caller table, and so as not to record an order confirmation slip from among those order confirmation slips detected by the order slip monitoring means for which the calling telephone number corresponding to the IP address of the user terminal that is the destination is not registered in the IP-caller table.

The ninth online shopping settlement method according to the present invention is an online shopping settlement method according to any of the fourth, sixth or eighth online shopping settlement methods configured such that if the order slip recording means does not record an order slip the order slip monitoring means does not deliver that order slip to the Web server and if the order slip recording means does not record an order confirmation slip, the order slip monitoring means does not deliver that order confirmation slip to the user terminal.

The tenth online shopping settlement method according to the present invention is an online shopping settlement method according to any of the fourth, sixth or eighth online shopping settlement methods configured such that regardless of whether an order slip and order confirmation slip are recorded or not recorded through the order slip recording means, the order slip monitoring means delivers the order slip to the Web server and the order confirmation slip to the user terminal.

The eleventh online shopping settlement method according to the present invention is an online shopping settlement method according to either the second or third online shopping settlement methods wherein the settlement means provides a means for calculating the online shopping charges that should be collected from the user based on the order slip and order confirmation slip recorded by the order slip recording means and requests payment therefor together with communication charges when invoicing the user terminal for communication charges.

The twelfth online shopping settlement method according to the present invention is an online shopping settlement method according to either the second or third online shopping settlement methods wherein the settlement means provides a means for calculating the online shopping charges that should be paid to the Web server based on the order slip and order confirmation slip recorded by the order slip recording means and pays those online shopping charges to the Web server.

An online shopping settlement system according to the present invention and the system therefor, involves a user terminal sending an order slip to a Web server for performing online shopping and the Web server sending an order confirmation slip to the user terminal for confirming receipt of the order slip, with the sending of those slips being detected by a communication common carrier providing communication services to the user terminal. Accordingly, the communication common carrier can ascertain the online shopping transaction performed between the user terminal and Web server without requiring procedures other than the sending and reception of the order slip and order confirmation slip by the user and Web shop.

As a communication common carrier acts as a substitute for collecting charges that should be paid by a user to a Web server in respect of transactions for which the requisite pair of order slip and order confirmation slip are prepared, users can enjoy online shopping using only simple procedures without using a credit card.

### BRIEF DESCRIPTION OF THE DRAWINGS

Specific embodiments of the present invention will now be described, by way of example only, with reference to the accompanying of drawings in which:

FIG. 1 is a schematic drawing of the present invention;

FIG. 2 is a block diagram showing a first embodiment of an online shopping system applied for the present invention;

FIG. 3 is a diagram showing an example of the contents of an account-subscriber table of a first embodiment according to the present invention;

FIG. 4 is a diagram showing an example of the contents of an IP-subscriber table of a first embodiment according to the present invention;

FIG. 5 is a diagram showing an example of the contents of a Web server IP table of a first embodiment according to the present invention;

FIG. 6 illustrates the flow for an example of processes occurring at the stage of connection to an ISP by a user terminal for a first embodiment according to the present invention;

FIG. 7 illustrates the flow for an example of processes until receipt of an order by a Web server, among the stages of online shopping occurring between a user terminal and a Web server for a first embodiment according to the present invention;

FIG. 8 illustrates the flow for an example of processes after receipt of an order by a Web server among the stages of online shopping occurring between a user terminal and a Web server for a first embodiment according to the present invention;

FIG. 9 is a drawing showing an example of the contents of an order slip for a first embodiment according to the present invention;

FIG. 10 is a drawing showing an example of the recording format of a slip storage used for a first embodiment according to the present invention;

FIG. 11 is a flow chart showing an example of processes of an invoicing part of a payment-invoice device used for a first embodiment according to the present invention;

FIG. 12 is a flowchart showing an example of processes of a payment part of a payment-invoice device used for a first embodiment according to the present invention;

FIG. 13 is a drawing showing an example of the flow of goods and charges occurring in an online shopping system of a first embodiment according to the present invention;

FIG. 14 illustrates the flow for an example of processes until receipt of an order by a Web server, among the stages of online shopping occurring between a user terminal and a Web server for another embodiment according to the present invention;

FIG. 15 illustrates the flow for an example of processes after receipt of an order by a Web server among the stages of online shopping occurring between a user terminal and a Web server for another embodiment according to the present invention;

FIG. 16 is a block diagram of an online shopping system of another embodiment according to the present invention;

FIG. 17 is a diagram showing an example of contents of an account-caller table for another embodiment according to the present invention;

FIG. 18 illustrates the flow for an example of processes occurring at the stage of connection from a user terminal to an ISP in another embodiment according to the present invention;

FIG. 19 is a diagram showing an example of contents of an IP-caller table of another embodiment according to the present invention;

FIG. 20 is a block diagram of an online shopping system of still another embodiment according to the present invention;

FIG. 21 a flowchart showing an example of processes until receipt of an order by a Web server, among the stages of online shopping occurring between a user terminal and a Web server for still another embodiment according to the present invention; and

FIG. 22 illustrates the flow for an example of processes after receipt of an order by a Web server among the stages of online shopping occurring between a user terminal and a Web server for still another embodiment according to the present invention.

### DETAILED DESCRIPTION OF THE PREFERRED EMBODIMENTS

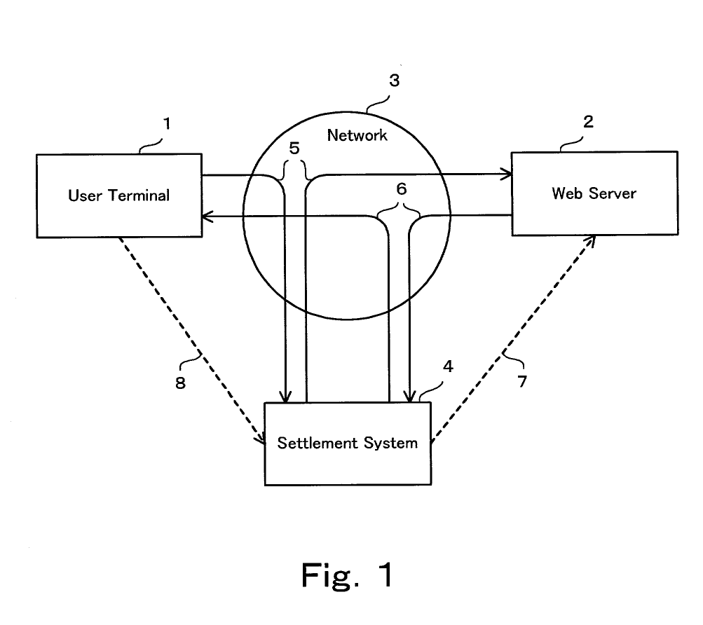

FIG. 1 is a schematic drawing of the present invention. In FIG. 1 user terminal 1 is an information processing device like a personal computer, installed in a home and a user using this user terminal 1 performs online shopping. Web server 2 is an information processing device like a workstation, providing online shopping services for user terminal 1. When online shopping is performed this user terminal 1 and Web server 2 are mutually connected via network 3 like the Internet or a telephone network. Generally, there would be a plurality of user terminals 1 and Web servers 2 but to simplify there are only one of each in FIG. 1.

Settlement system 4 is a system of a communication common carrier that user terminal 1 has joined as a subscriber, that in addition to having payment request functions for communication charges covering communication services provided to user terminal 1, acts as a substitute collecting online shopping service charges that user terminal 1 should pay Web server 2. That is to say, online shopping charges are collected from a user of user terminal 1 (8 of FIG. 1) and paid to Web server 2 (7 of FIG. 1). Settlement system 4 for substitute payment collection detects both order slip 5 forwarded from user terminal 1 to Web server 2 and order confirmation slip 6 forwarded from Web server 2 to user terminal 1 to confirm receipt of order slip 5. Substitute collection of online shopping charges is only executed in respect of transactions for which the pair of order slip 5 and order confirmation slip 6 are prepared.

A number of basic methods are conceivable for detection of order slip 5 and order confirmation slip 6 by settlement system 4. One such method involves monitoring of packets forwarded from user terminal 1 to Web server 2 via network 3 and packets forwarded from Web server 2 to user terminal 1 via network 3, from a suitable point along the communication routes between user terminal 1 and Web server 2, to acquire packets for order slip 5 and order confirmation slip 6 if they appear. To determine which packet is an order slip 5 and which packet is an order confirmation slip 6, port numbers for online shopping for example can be used, worked out in advance and exclusively set for order slip 5 and order confirmation slip 6, for facilitating forwarding of order slip 5 and order confirmation slip 6 between user terminal 1 and Web server 2. This enables a packet amongst packets flowing in the direction from user terminal 1 to Web server 2 with an online shopping port number to be detected as an order slip 5 and a packet amongst packets flowing in the opposite direction with an online shopping port number to be detected as an order confirmation slip 6. Because generally user terminal 1 is connected to the Internet via an Internet service provider, it is desirable to establish the packet monitoring location between the Internet service provider and network 3. Further, it is suitable for the equipment monitoring the packets to be provided with firewall functionality preventing the flow of an irregular order slip 5 or order confirmation slip 6 to Web server 2 or user terminal 1 but it is also suitable for the equipment not to be provided with firewall functionality.

Another method for detection of an order slip 5 or order confirmation slip 6 by settlement system 4 is to establish a point for relaying an order slip 5 and order confirmation slip 6 and ensure that when user terminal 1 forwards an order slip 5 to Web server 2 and when Web server 2 forwards an order confirmation slip 6 to user terminal 1 that those slips definitely pass through that relay point. As long as user terminal 1 and Web server 2 know just the location of the relay point (its address on the network), the relay point can be set at any desired location on network 3. In the same manner as for the method described previously, it is suitable for the relay point to be provided with firewall functionality preventing relay of an irregular order slip 5 or order confirmation slip 6 to Web server 2 or user terminal 1 but it is also suitable for the relay point not to be provided with firewall functionality.

If a user performing online shopping using user terminal 1 is not a genuine user an online shopping transaction based on an order slip 5 coming from that user is an illegal transaction and therefore must be excluded. If such a transaction is not excluded settlement system 4 will collect charges from a genuine user causing considerable injury to that genuine user. Generally, a password is used as the method for verifying a user however there is a risk that once a password is leaked it may be used adversely. Accordingly, in addition to certification through a password it is desirable to have another certification method operating in parallel. Because settlement system 4 has user certification based on conditions of the subscriber line of user terminal 1 operating together with user certification based on the calling telephone number of user terminal 1 it provides a highly accurate form of user certification, facilitating very secure online shopping.

The basic constitution of the present invention will now be described for a number of embodiments.

First Embodiment

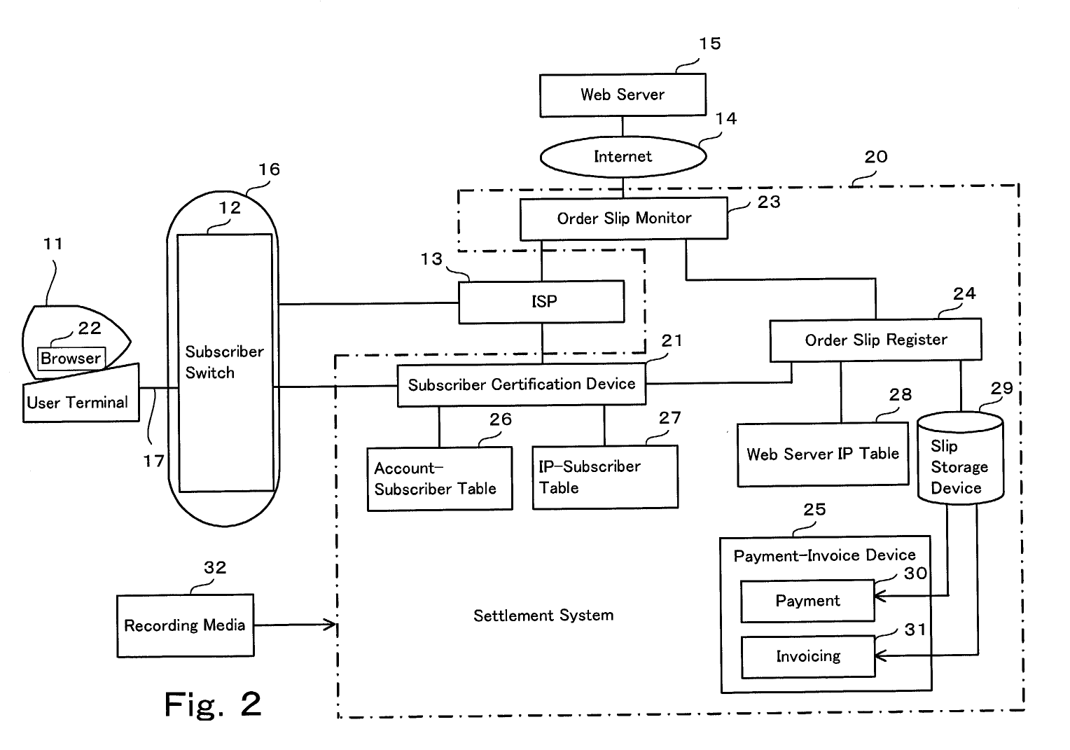

FIG. 2 is a block diagram showing a first embodiment of an online shopping system applied for the present invention. In FIG. 2, user terminal 11 is an information processing device like a personal computer installed in a home, that in addition to providing hardware like a CPU, memory, keyboard, CRT and modem, is also installed with the necessary software including browser 22. Web server 15 is an information processing device like a workstation, providing online shopping services and in addition to providing hardware like a CPU, memory and modem, server 15 is installed with the software required for a server. Generally, there would be a plurality of user terminals and Web servers but there are only one of each in FIG. 2.

User terminal 11 is connected to subscriber switch 12 through subscriber line 17. This subscriber line 17 and subscriber switch 12 are part of network 16 of a communication common carrier of which user terminal 11 is a subscriber. A user of user terminal 11 pays communication charges to that communication common carrier and uses the communication service. Further, the user of user terminal 11 is a subscriber of Internet service provider (ISP) 13 and when accessing Web server 15 via Internet 14, this user connects to ISP 13 through a dial-up connection and uses the Internet connection service provided by ISP 13.

Settlement system 20, a settlement system of the communication common carrier having network 16, has functionality for invoicing user terminal 11 for communication charges and functionality for acting as a substitute to collect online shopping charges that should be paid to Web server 15 by user terminal 11. The main parts of this settlement system 20 are subscriber certification device 21 that includes account-subscriber table 26 and IP-subscriber table 27, order slip monitor 23, order slip register 24 that includes a Web server IP table and slip storage 29, and payment-invoice device 25 connected to slip storage 29. This settlement system 20 may be provided through one or multiple computers, workstations for example, and an online shopping settlement program. Recording media 32 shown in FIG. 2 is a recording media capable of machine read-in of a CD-ROM, semiconductor memory or magnetic disk for example with an online shopping settlement program recorded therein. The online shopping settlement program recorded in recording media 32 is read in by a computer or computers of settlement system 20 and control of the operations of that computer or computers realizes control of subscriber certification device 21, order slip monitor 23, order slip register 24 and payment-invoice device 25.

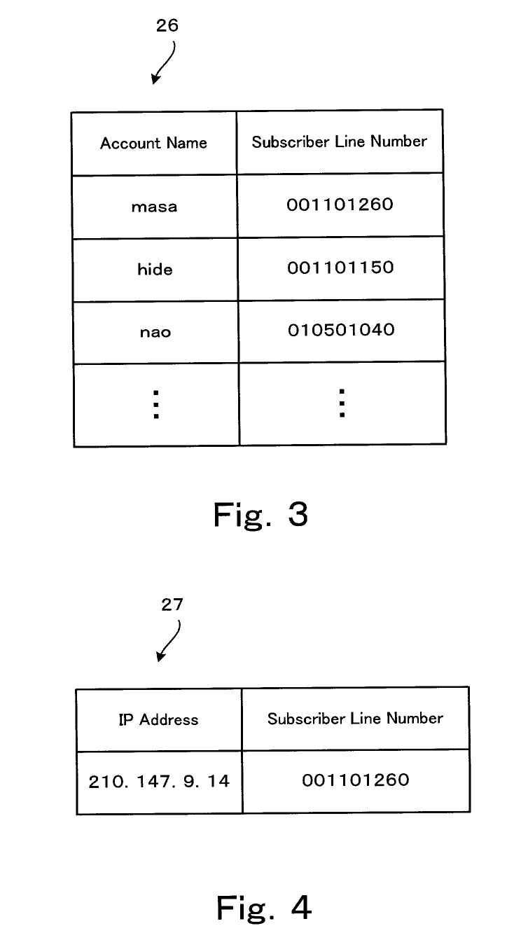

Subscriber certification device 21 is a device for verifying whether or not user terminal 11 with a dial-up connection to ISP 13 is a genuine user terminal or not and in this embodiment device 21 performs certification based on conditions on subscriber line 17 of user terminal 11 through a request from ISP 13. Accordingly, in addition to being connected to ISP 13, device 21 is connected to subscriber switch 12 directly accommodated by user terminal 11. As shown in FIG. 3 a list coordinating account names allocated for each user terminal 11 by ISP 13 and the appropriate subscriber line number for each user terminal is held in advance in account-subscriber table 26. Subscriber certification device 21 receives from ISP 13, the account name of user terminal 11 and the telephone number of ISP 13, accesses account-subscriber table 26 using the account name as the key to retrieve the appropriate subscriber line number, makes an inquiry to subscriber exchange 12 on the condition of that subscriber line and only as long as that subscriber line is on the telephone to the telephone number of ISP 13, device 21 affirms that the user terminal is genuine and notifies that to ISP 13. If that subscriber line does not have a dial-up connection or is dialed up to a telephone number other than a telephone number of ISP 13, device 21 does not affirm that user terminal as genuine. ISP 13 certifies users with reference to the certification results of subscriber certification device 21.

When user certification from ISP 13 is successful ISP 13 dynamically allocates an IP address for user terminal 11 and subscriber certification device 21 receives the allocated IP address from ISP 13 and records the relationship between the IP address on user terminal 11 and the subscriber line number in IP-subscriber table 27 as shown in FIG. 4. This record remains while user terminal 11 is connected to ISP 13 and is extinguished when that connection is disconnected. The relationship between the genuine user terminal 11 IP address and the subscriber line number recorded in IP-subscriber table 27 is used for deciding the validity of an order slip and order confirmation slip at subsequent times when online shopping is performed.

Order slip monitor 23 is set up between ISP 13 and Internet 14 and is a type of packet monitor with processing functionalities for detecting an order slip addressed to Web server 15 forwarded from user terminal 11 via ISP 13 along Internet 14 at times when online shopping is performed and detecting an order confirmation slip forwarded via ISP 13 to user terminal 11 by Web server 15 to confirm receipt of the order slip. With this embodiment, the configuration is worked out in advance so that when browser 22 of user terminal 11 forwards an order slip to Web server 15 and when Web server 15 forwards an order confirmation slip to user terminal 11 those slips are forwarded to online shopping specified port numbers specifically set for the order slip and order confirmation slip. Accordingly, by detecting packets with those specified port numbers from among those packets flowing between ISP 13 and Internet 14, order slip monitor 23 detects an order slip and order confirmation slip. Order slip monitor 23 conveys an order slip and order confirmation slip thus detected to order slip register 24.

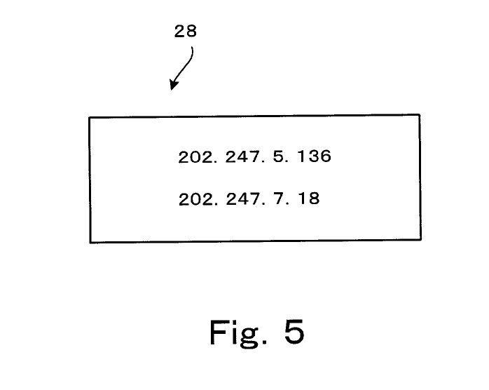

Order slip register 24 investigates the validity of an order slip and order confirmation slip conveyed from order slip monitor 23 and records only valid order and order confirmation slips in slip storage 29, a medium like a magnetic disk device. To investigate the validity of an order slip and order confirmation slip, order slip register 24 makes an inquiry to subscriber certification device 21 and a check using IP-subscriber table 27 is performed. Basically, an order slip for which the subscriber line number corresponding to the order slip source IP address is not registered in IP-subscriber table 27 and an order confirmation slip for which the subscriber line number corresponding to the order confirmation slip destination IP address is not registered in IP-subscriber table 27 are judged to be invalid. Further, an IP address list from Web server 15 for which settlement system 20 performs settlement in substitute is stored in advance in Web server IP table 28, shown in FIG. 5, and a check is performed by order slip register 24/subscriber certification device 21 using this Web server IP table 28. Basically, an order slip for which the order slip destination IP address is not registered in Web server IP table 28 and an order confirmation slip for which the order confirmation slip source IP address is not registered in Web server IP table 28 are judged to be invalid.

Payment-invoice device 25 collects online shopping charges from user terminal 11 in respect of online shopping transactions for which the requisite order slip and order confirmation slip pair are prepared and recorded in slip storage 29 and pays those charges to Web server 15. Device 25 includes payment part 30 and invoicing part 31. Invoicing part 31 calculates charges for online shopping which should be collected from user terminal 11 based on an order slip and order confirmation slip recorded in slip storage 29 and invoices user terminal 11 for those charges together with and at the same time as invoicing user terminal 11 for communication charges. The communication common carrier, ascertaining the user name, address and telephone number of user terminal 11 for invoicing communication charges, sends out a payment invoice for shopping charges to the ascertained invoice recipient. Payment of shopping charges by the user is made by the same methods used for payment of communication charges, with payment into a bank account, using payment at a local bank or convenience store. Payment part 30 calculates charges that should be paid to Web server 15 based on an order slip and order confirmation slip recorded in slip storage 29, which charges are paid by deposit into a bank account for example.

The operations of this embodiment will now be described in the following order: (1) the advance preparations stage, (2) the stage of connection from user terminal 11 to ISP 13, (3) the stage of online shopping between user terminal 11 and Web server 15 and (4) the payment and invoicing stage.

(1) The Advance Preparations Stage

Advance preparations involve registering in account-subscriber table 26 of subscriber certification device 21, the combination of the account name of user terminal 11 used when making a dial-up connection to ISP 13 and a subscriber line number that account name is able to use. This subscriber line number is generally for the home of the user where user terminal 11 is installed.

Further, the IP address of Web server 15 used for settlement by settlement system 20 is registered in Web server IP table 28 of order slip register 24 as shown in FIG. 5.

(2) The Stage of Connection from User Terminal 11 to ISP 13

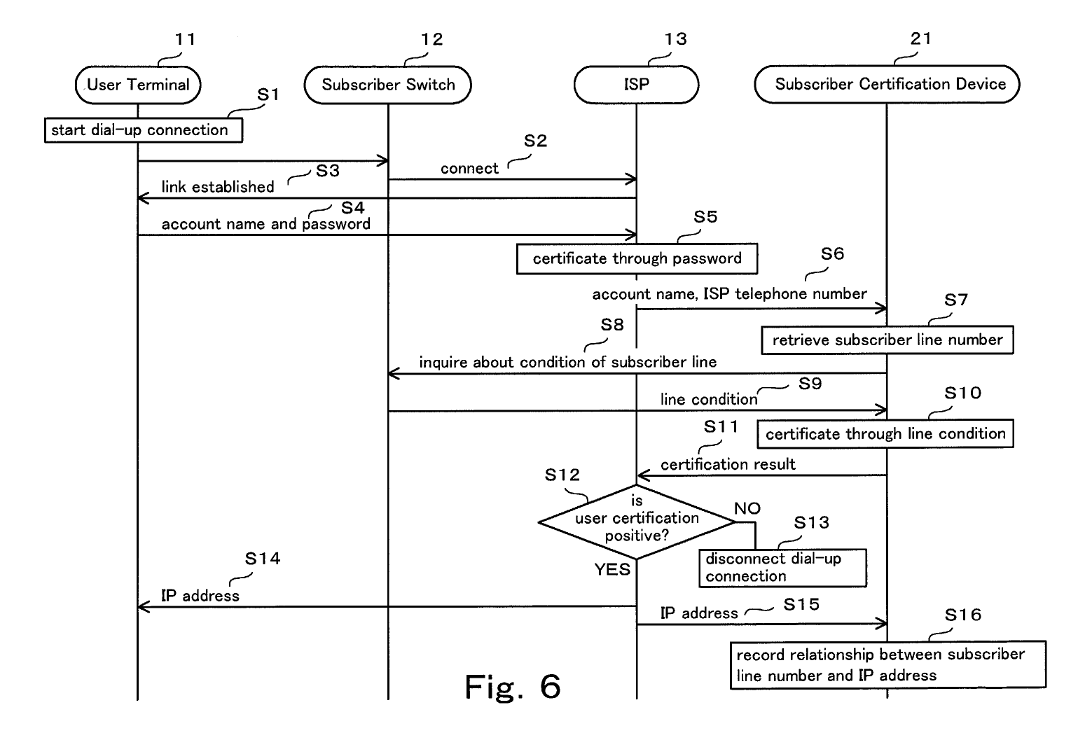

The flow of processes at this stage are shown in FIG. 6. Firstly, a dial-up connection is opened to an access server of ISP 13 through a modem on user terminal 11 connected to subscriber line 17 accommodated by subscriber switch 12 (step S1 of FIG. 6). User terminal 11 connects to ISP 13 (step S2) and a link is established during that period (step S3). PPP, the most common connection is used for remote access procedures. At the PPP certification phase the account name and password (in the case of a PAP format) are forwarded from user terminal 11 (step S4). Normally, an access server of ISP 13 implements a user certification request on the certification server and performs certification through a password (step S5), however for this embodiment, if certification through the password is successful the account name input and telephone number of ISP 13 itself are forwarded from user terminal 11 to subscriber certification device 21 (step S6) and further user certification is implemented through ascertaining conditions of the subscriber line as described below. When the telephone number of ISP 13 is registered in advance in subscriber certification device 21, it is sufficient for only the account name to be forwarded from ISP 13 to subscriber certification device 21.

Firstly, subscriber certification device 21 accesses account-subscriber table 26 with the account name received from ISP 13 and rretrieves the subscriber line number allowing a dial-up connection (step S7). Next, device 21 inquires to subscriber switch 12 about the condition of that subscriber line (step S8), receives information on the condition of that subscriber line. (step S9) and performs user certification based on those line conditions (step S10). Subscriber switch 12 is an electronic switching device wherein information on whether each subscriber line housed within itself is presently calling or not and if it is calling, the telephone number being called, resides in memory, with this memory being referred to when responding to an inquiry. If that subscriber line is not being used or is being used for communicating with a party other than ISP 13, subscriber certification device 21 returns a certification failure to ISP 13 but if that subscriber line is communicating with ISP 13, device 21 returns a certification positive result to ISP 13 (step S11).

ISP 13 performs the final user certification with reference to the certification result from subscriber certification device 21 (step S12). In other words, even if certification through a password succeeds, if certification based on the condition of the subscriber line fails, user certification is NG (no good). Only when both those forms of certification are successful is user certification judged positive, OK. If user certification is judged NG, ISP 13 disconnects the dial-up connection with user terminal 11 (step S13). If user certification is judged OK ISP 13 dynamically assigns an IP address for user terminal 11 (step S14) and notifies this assigned IP address to subscriber certification device 21 (step S15). Subscriber certification device 21 stores the relationship between the subscriber line number and IP address assigned for that number in IP-subscriber table 27 as shown in FIG. 4 (step S16).

(3) The Stage of Online Shopping Between User Terminal 11 and Web Server 15

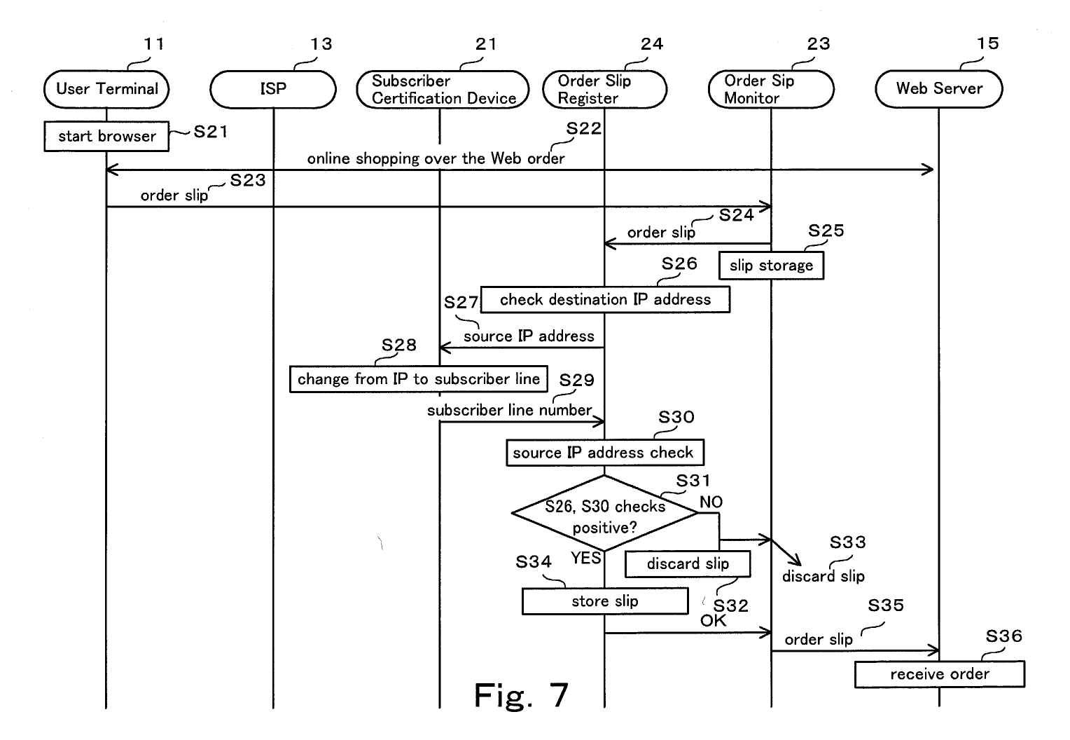

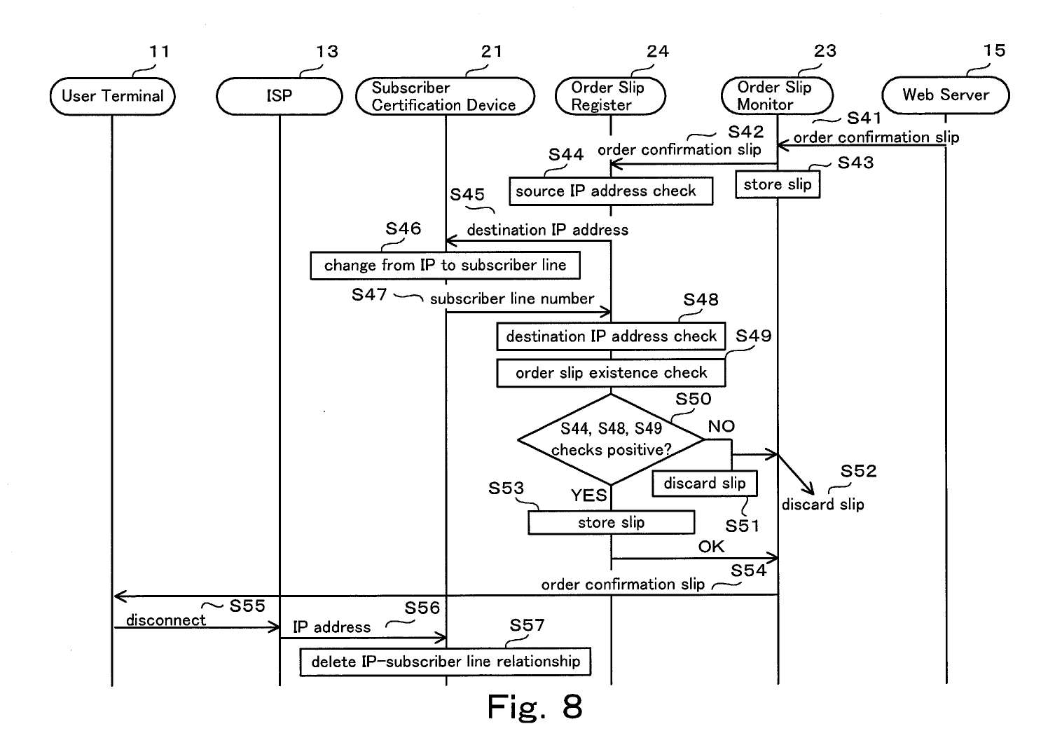

The flow of processes at this stage are shown in FIGS. 7 and 8. Auser of user terminal 11 browser 22 (step S21 of FIG. 7), connects by HTTP to Web server 15 and commences online shopping (step S22). When ordering goods, that user sends an order slip, recording things like the details of the order, from browser 22 by TCP addressed to Web server 15 (step S23). At this point, the destination IP address of the packet for the order slip is the IP address of Web server 15, the source IP address is set as the IP address of user terminal 11 and the destination port number is a port number for online shopping, that is set as a port number specific to the order slip and order confirmation slip.

Order slip monitor 23 monitors packets going out from ISP 13 to Internet 14 and when monitor 23 detects a packet with a port number for online shopping, monitor 23 forwards that packet as an order slip packet, to order slip register 24 (step S24). Further, with this embodiment, as order slip monitor 23 is provided with firewall functionality, the order slip is temporarily stored in order slip monitor 23 (step S25) and at the point at which the order slip is judged from order slip register 24 to be a valid order slip, the slip is forwarded to Web server 15. A packet other than an order slip going out from ISP 13 to Internet 14 passes straight through order slip monitor 23.

If order slip register 24 receives an order slip from order slip monitor 23, register 24 performs the next 2 checks. Firstly, register 24 performs a destination IP address check to determine whether or not the destination IP address of the order slip it has received is registered in Web server IP table 28 (step S26). Next, register 24 performs a source IP address check to determine whether or not the subscriber line number corresponding to the source IP address of that packet is registered in IP-subscriber table 27 (step S30). Register 24 forwards the source IP address to subscriber certification device 21 for this check (step S27). Device 21 accesses IP-subscriber table 27 using that source IP address (step S28) and returns the results to register 24 (step S29). If the result is positive the retrieved subscriber line number is returned.

If the source IP address of an order slip packet is valid, corresponding to the subscriber line, moreover the destination IP address is a regular IP address registered in Web server IP table 28, order slip register 24 decides that order slip is valid, but any order slip not fulfilling those conditions is determined to be an irregular order slip (step S31). If there is an irregular order slip register 24 discards that order slip (step S32) and informs order slip monitor 23 that that order slip is not to be forwarded. Monitor 23 discards the temporarily stored packet for that order slip (step S33). When the order slip is valid however, register 24 records that order slip in order slip storage 29 (step S34) and informs monitor 23 that that order slip should be forwarded. Monitor 23 then forwards the temporarily stored packet for that order slip to Web server 15 (step S35). Web server 15 receives this order slip and performs procedures for receiving the order (step S36).

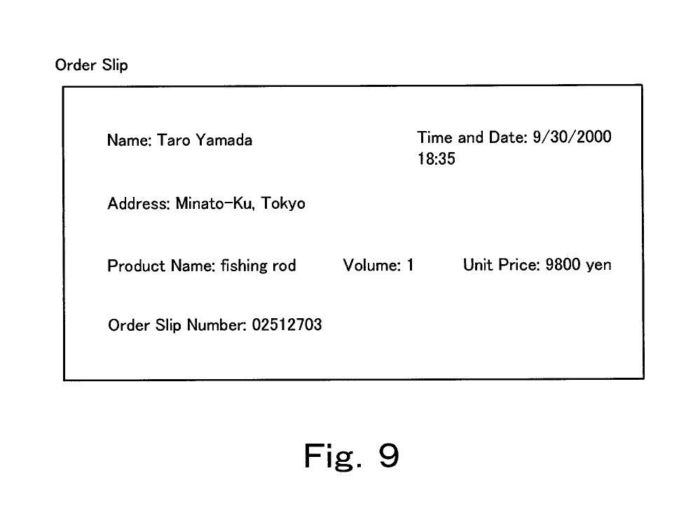

FIG. 9 shows an example of an order slip. This example of an order slip includes the name and address of the party placing the order, the time and date of the order, the goods that party wishes to purchase and the volume of that goods, the unit price of the goods and an order slip number for uniquely identifying that order slip.

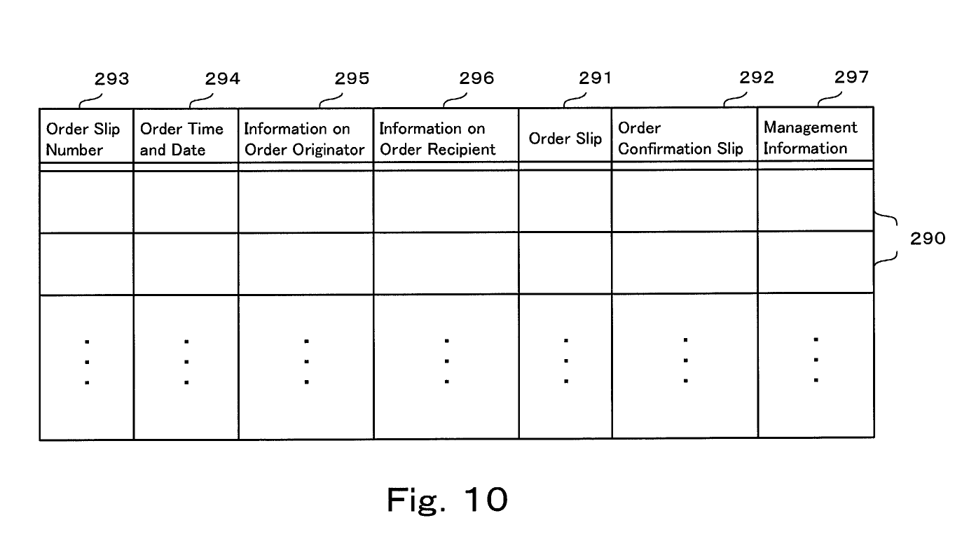

FIG. 10 shows an example of the recording format of a slip storage 29. In this example there are multiple entries 290 recording the pair of an order slip and corresponding order confirmation slip and each entry 290 has, in addition to areas 291 and 292 recording the order slip and order confirmation slip, areas 293 through 297 recording the order slip number, date and time of the order, information on the order originator, information on the order recipient and management information. The order slip number and order time and date recorded for an order slip are recorded in the order slip number of area 293 and the order time and date of area 294 respectively. Information specifying user terminal 11 that is placing the order is recorded in information on the order originator in area 295, recording the subscriber line number for the user terminal 11 notified by subscriber certification device 21 at step S29 in FIG. 7 for example. Information specifying the order recipient, Web server 15, is recorded in information on the order recipient in area 296 recording the destination IP address of the order slip packet (the IP address of Web server 15) for example. Things like flags for managing whether or not invoicing the user for charges is complete and whether or not payment of charges to the Web server has been completed in respect of the transaction for which the requisite order slip and order confirmation slip are recorded in the appropriate entry 290, are recorded in management information of area 297.

Operations performed at Web server 15 after receiving an order will now be described with reference to FIG. 8. Web server 15 upon receiving an order slip, forwards an order confirmation slip by TCP to user terminal 11 to notify user terminal 11 that the order slip has been properly received (step S41). This order confirmation slip includes a copy of the order slip received and it may also be suitable to include information like the Web shop name for example as additional information. The source IP address of the order confirmation slip packet is set as the IP address of Web server 15 and the destination IP address is set as the IP address of user terminal 11 while the destination port number is set as a port number for online shopping.

Order slip monitor 23 also monitors packets coming into ISP 13 from Internet 14 and when monitor 23 detects a packet with a port number for online shopping, monitor 23 forwards that packet as an order confirmation slip packet, to order slip register 24 (step S42). Further, with this embodiment, as order slip monitor 23 is provided with firewall functionality, the order confirmation slip is temporarily stored in order slip monitor 23 (step S43) and at the point at which the order confirmation slip is judged from order slip register 24 to be a valid order confirmation slip, the slip is forwarded to user terminal 11. A packet other than an order confirmation slip coming into ISP 13 from Internet 14 passes straight through order slip monitor 23.

If order slip register 24 receives an order confirmation slip from order slip monitor 23, register 24 performs the next 2 checks. Firstly, register 24 performs a source IP address check to determine whether or not the source IP address of the order confirmation slip it has received is registered in Web server IP table 28 (step S44). Next, register 24 performs a destination IP address check to determine whether or not the subscriber line number corresponding to the destination IP address of that packet is registered in IP-subscriber table 27 (step S48). Register 24 forwards the destination IP address to subscriber certification device 21 for this check (step S45). Device 21 accesses IP-subscriber table 27 using that destination IP address (step S46) and returns the results to register 24 (step S47). If the result is positive the retrieved subscriber line number is returned. Next, register 24 performs a check to ascertain the existence of the order slip, to determine whether or not the order slip corresponding to the order confirmation slip is registered in slip storage 29 (step S49). This check is performed by accessing slip storage 29 that has a recording format as shown in FIG. 10, using the order slip number in a copy of the order slip included in the order confirmation slip to determine whether or not there is an entry in which the corresponding order slip is recorded.

If the source IP address of an order confirmation slip packet is valid, corresponding to the subscriber line number, the source IP address is a regular IP address registered in Web server IP table 28 and the corresponding order slip is present in order slip storage 29, order slip register 24 decides that order confirmation slip is valid, but any order confirmation slip not fulfilling those conditions is determined to be an irregular order confirmation slip (step S50). If there is an irregular order confirmation slip register 24 discards that order confirmation slip (step S51) and informs order slip monitor 23 that that order confirmation slip is not to be forwarded. Monitor 23 discards the temporarily stored packet for that order confirmation slip (step S52). When the order confirmation slip is valid however, register 24 records that order confirmation slip in the entry in order slip storage 29 in which the corresponding order slip is recorded (step S53) and informs monitor 23 that that order confirmation slip should be forwarded. Monitor 23 then forwards the temporarily stored packet for that order confirmation slip to user terminal 11 (step S54). Browser 22 of user terminal 11 receives this order confirmation slip and displays it, thereby allowing the user to confirm that the order has been successful.

As the user of user terminal 11, completing his online shopping, disconnects the dial-up connection (step S55), ISP 13 notifies subscriber certification device 21 of the IP address of the thus disconnected user (step S56). Device 21 then deletes the relationship between that IP address and the subscriber line number from IP-subscriber table 27 (step S57).

(4) The Payment and Invoicing Stage

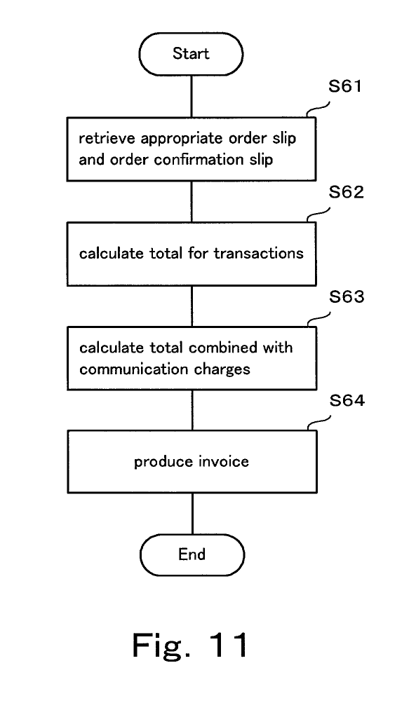

As invoicing part 31 of payment-invoice device 25 of the communication common carrier invoices the relevant subscriber for communication charges, device 25 also invoices the subscriber for online shopping charges. An example of the processes performed for each subscriber is shown in FIG. 11.

Firstly, invoicing part 31 accesses slip storage 29 using the subscriber line number of the relevant subscriber and extracts entries 290 for which the same subscriber line number is recorded in area 295 as shown in FIG. 10, for which the pair of order slip and order confirmation slip are recorded in areas 291 and 292 of that FIG. and for which the management information of areas 297 shows that there is as yet no invoice (step S61). Next, a calculation is made for each entry 290 thus extracted using the unit price and volumes indicated in the order slip recorded in area 291 and an invoice amount for each of these transactions is then requested, after which a calculation is made of the total amount calculated for all the extracted entries (step S62). This is added together with communication charges for the appropriate subscriber (step S63) and an invoice form is produced (step S64). When this invoice form is produced the management information of area 297 of the entry 290 invoiced is changed to reflect the fact that the invoice is complete. Apart from the total invoice amount, the invoice form has recorded in it, details of each individual online shopping transaction. A statement is produced based on the recorded order slip.

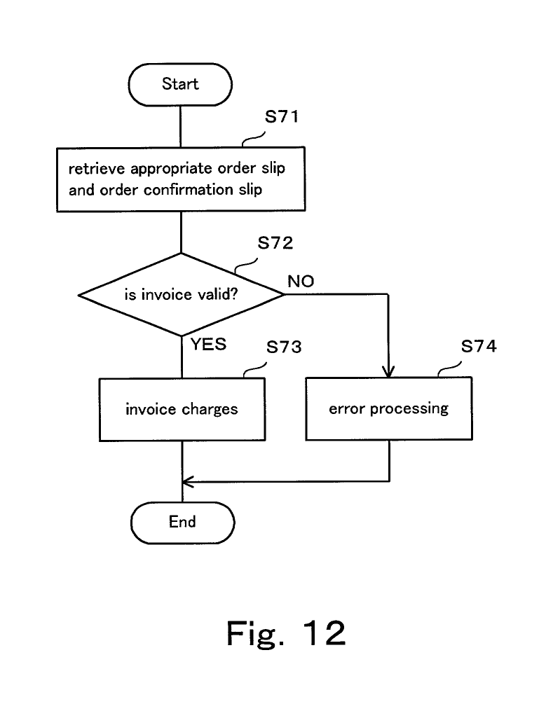

When payment part 30 of payment-invoice device 25 has a request for online shopping charges from Web server 15, part 30 calculates online shopping charges that should be paid to Web server 15 based on the order slip and order confirmation slip recorded in slip storage 29 and pays this to Web server 15 by a method such as deposit into a bank account. An example of processes performed by payment part 30 in the case of payment on a per transaction basis is shown in FIG. 12.

If an invoice specifying an order slip number comes from Web server 15, payment part 30 accesses slip storage 29 using that order slip number, and retrieves the entry 290 recording the same order slip number in area 293 as shown in FIG. 10 (step S71). Next, part 30 decides whether or not that invoice is valid (step S72). If that retrieving operation for entry 290 is successful, if the IP address in the information on order recipient recorded in area 296 of that entry 290 agrees with the IP address of Web server 15 that is the appropriate order originator, if the order slip and order confirmation slip pair are recorded in area 291 and area 292 and if the management information of area 297 shows payment is yet to be made, the invoice is valid, however if those conditions are not fulfilled, the invoice is determined to be invalid. When the invoice is valid a calculation is made using the unit price and volumes indicated in area 291 for the appropriate entry 290 and a request is made for payment of that amount, which amount is paid to Web server 15, while the management information in area 297 is changed to reflect the fact that the invoice is complete (step S73). Of course it may be suitable to request payment after deducting a set amount for commissions. If the invoice is invalid on the other hand, error processes are performed like notifying the invoice originator of the invalidity (step S74).

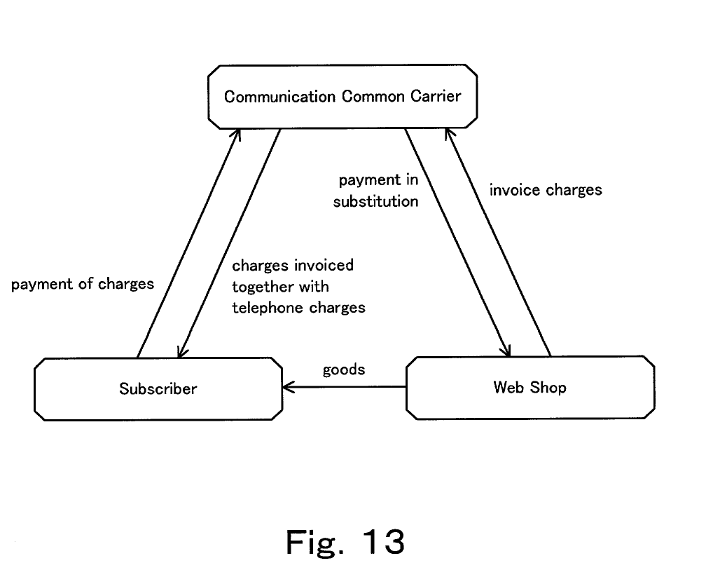

An example of the flow of goods and charges occurring in an online shopping system of this embodiment is shown in FIG. 13. In accordance with the order slip received from Web server 15, the Web shop forwards the goods to the user and invoices the communication common carrier for the appropriate charges. If the communication common carrier is invoiced by the Web shop concerning items for which the two slips being the order slip and order confirmation slip are prepared in slip storage 29, the communication common carrier advances the appropriate amount for charges. The communication common carrier collects Web shopping charges from the user at the same time as collecting telephone charges. The user receives the goods from the Web shop and pays the appropriate charges to the communication common carrier.

The operations of this embodiment will now be described using a concrete example.

In the following example the account name allocated to a user of user terminal 11 by ISP 13 is “masa”, the subscriber line number of user terminal 11 is “001101260”, as shown in FIG. 3 the relationship between the account name masa and subscriber line number 001101260 is approved by subscriber certification device 21 and recorded in account-subscriber table 26. Further, the IP address of Web server 15 is “202.247.5.136” and this is registered as a regular IP address shown in FIG. 5, in Web server IP table 28 of order slip register 24.

If the user of user terminal 11 establishes a dial-up connection from the subscriber line accommodated by subscriber switch 12 to an access server of ISP 13, the account name masa and password are forwarded to ISP 13 from user terminal 11 through the PPP certification phase. ISP 13 forwards the account name masa to subscriber certification device 21. From the account name thus received, device 21 requests subscriber line number 001101260 from account-subscriber table 26 as shown in FIG. 3, and makes an inquiry to subscriber switch 12 about the condition of that subscriber line. Regardless of whether subscriber line 001101260 is or is not being used, if that subscriber line number is connected to anything other than an ISP 13 access server, that connection is judged to be an illegal access which is notified to ISP 13. If subscriber line number 001101260 is being used and is connected to an access server of ISP 13 device 21 returns a certification OK result to ISP 13. If certification is OK at ISP 13, ISP 13 assigns IP address 210.147.9.14 to user terminal 11 and notifies that address to device 21. Device 21 stores the relationship between 210.147.9.14 and 001101260 in IP-subscriber table 27 as shown in FIG. 4.

After the dial-up connection is established, browser 22 is started on user terminal 11 and connected to Web server 15 (at IP address 202.247.5.136) and then online shopping commences. If the user purchases “one fishing rod at 9800 yen” browser 22 forwards an order slip as shown in FIG. 9 to an online shopping port number. If order slip monitor 23 detects this order slip to go from ISP 13 to Internet 14, monitor 23 forwards that order slip with the source and destination IP addresses to order slip register 24. Register 24 confirms that the source IP address for this data, 210.147.9.14 is present in IP-subscriber table 27 as shown in FIG. 4 and that the destination IP address 202.247.5.136 is registered in Web server IP table 28 as shown in FIG. 5 before determining that this order slip is valid and storing the slip in slip storage 29. Order slip monitor 23 forwards the order slip to Web server 15.

Receiving the order slip thus forwarded, Web server 15 forwards an order confirmation slip to user terminal 11 using an online shopping port number. If order slip monitor 23 detects this order confirmation slip monitor 23 forwards the order confirmation slip with the source and destination IP addresses to order slip register 24. Register 24 confirms that the destination IP address 210.147.9.14 is present in IP-subscriber table 27 as shown in FIG. 4 and that the source IP address 202.247.5.136 is registered in Web server IP table 28 as shown in FIG. 5, then confirms that the corresponding order slip is registered in slip storage 29 before registering the order confirmation slip in slip storage 29. Order slip monitor 23 forwards this order confirmation slip to user terminal 11 thus allowing the user receiving the confirmation slip to recognize that the order has been made.

If the dial-up connection of user terminal 11 is disconnected ISP 13 notifies subscriber certification device 21 of the fact that the connection of IP address 210.147.9.14 has disconnected. Device 21 deletes the relationship between IP address 210.147.9.14 and subscriber line number 001101260 from IP-subscriber table 27.

The Web shop posts the 9800 yen fishing rod ordered to Taro Yamada and invoices the communication common carrier for 9800 yen. Settlement system 20 of the communication common carrier confirms that the appropriate order slip and order confirmation slip pair are prepared and recorded in slip storage 29 and pays the appropriate charges to the Web shop. Taro Yamada pays the 9800 yen together with appropriate telephone charges to the communication common carrier.

Because in this embodiment, when a dial-up connection is made user certification requires not only password agreement but a check is made on the calling subscriber line also, a high degree of security can be maintained. The reason for this is that an account and password are simply character string information and if somehow they were to become known by another person or successfully guessed, someone else could easily pretend to be the real user. By performing a check down to the calling subscriber line however, it becomes necessary for any pretender to perform acts like physically replacing the subscriber line for example, but because generally this is very difficult, the act of one person disguising himself as a valid user can be prevented. Where a mobile terminal like a mobile telephone is used, it is suitable to use a terminal identifying number for certification instead of a subscriber line number.

Further, with this embodiment, safe Web shopping can be performed without sending a credit card number for example, along the Internet. The reason for this is as follows: normally, when performing Web shopping a user inputs his own credit card number and the Web shop side uses that number to collect charges from the credit card company. This credit card number is simply a character string and if another person learns that number that person can easily pretend to be the real user who owns that number. With this embodiment however, it becomes possible for a user to perform Web shopping without using a credit card number. Further, viewed from the position of a Web shop, the impact is nothing more than changing the party to which the payment invoice is made from a credit card company to the communication common carrier.

Second Embodiment

This embodiment dispenses with the firewall functionality used in the first embodiment so that the second embodiment differs to the first embodiment in that a decision by order slip monitor 23 on the validity or invalidity of an order slip and order confirmation slip in order slip register 24 is not relevant and those slips are forwarded to Web server 15 and user terminal 11. The constitution and operation of this embodiment will now be described focusing on the points of differentiation between this embodiment and the first embodiment.

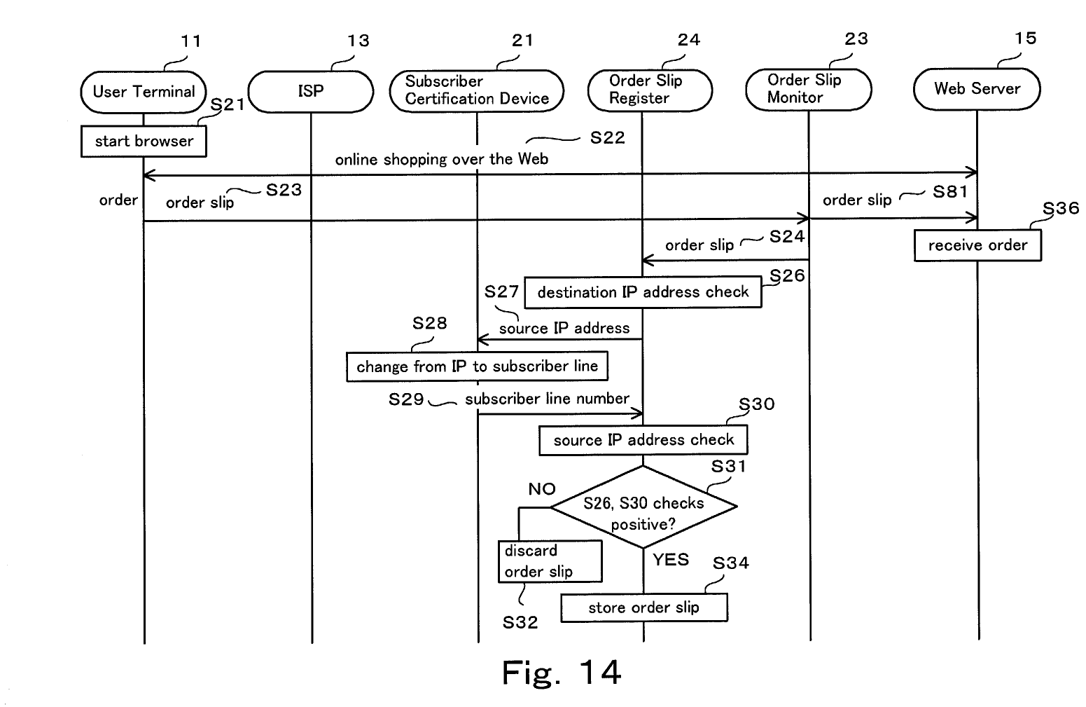

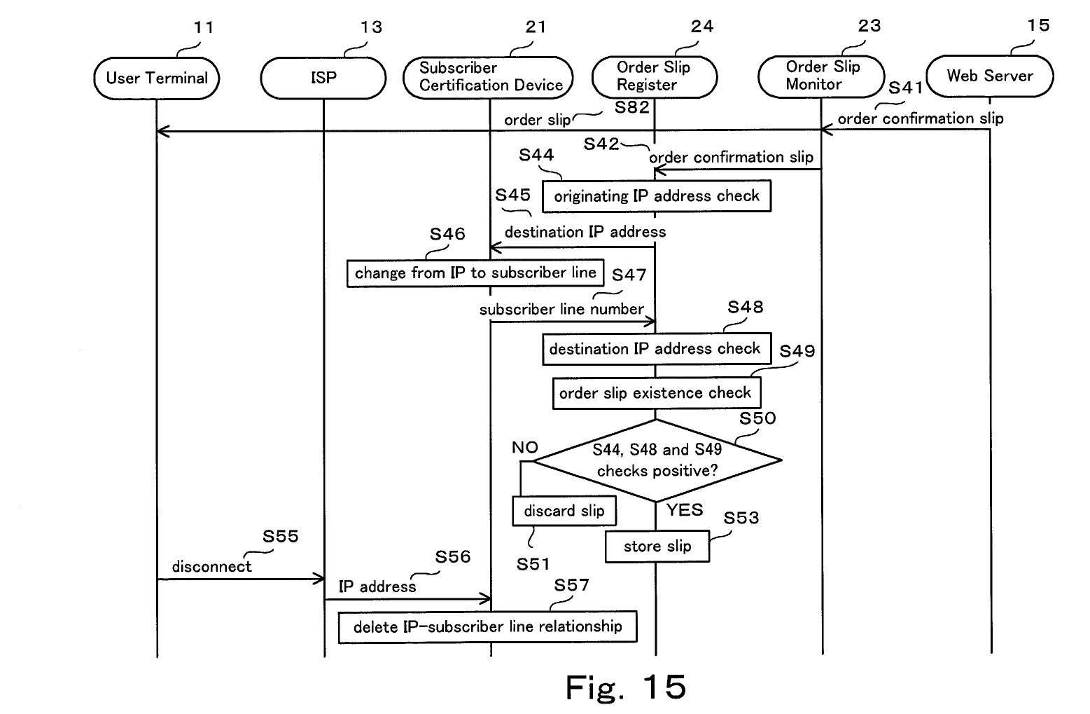

FIGS. 14 and 15 illustrate the flow occurring at the online shopping stage between user terminal 11 and Web server 15 for this embodiment. In the same manner as for the first embodiment, when the user orders goods an order slip in which the IP address of Web server 15 is set for the destination IP address, the IP address of user terminal 11 is set for the source IP address and an online shopping port number is set for the destination port number is forwarded from user terminal 11 to Web server 15 (step S23), however if order slip monitor 23 detects a packet going out from ISP 13 to Internet 14 set with an online shopping port number, in addition to forwarding that packet to order slip register 24 as an order slip packet (step S24) as occurs in the first embodiment, in this embodiment that packet is unconditionally forwarded to Web server 15 (step S81). In other words, at order slip register 24 which receives the order slip, a decision is made by the same method as for the first embodiment as to whether that packet is valid or invalid, however order slip monitor 23 forwards that order slip to Web server 15 regardless of the result of that decision. Accordingly, the instructions from order slip register 24 to order slip monitor 23 on whether forwarding of the order slip is required or not required are dispensed with in this embodiment.

Further, in the same manner as for the first embodiment, with this embodiment, when Web server 15 receives an order slip an order confirmation slip with the IP address of Web server 15 set as the source IP address, the IP address of user terminal 11 set as the destination IP address and an online shopping port number set as the destination port number is forwarded to user terminal 11, however if order slip monitor 23 detects a packet coming into ISP 13 from Internet 14 set with an online shopping port number, in addition to forwarding that packet to order slip register 24 as an order slip confirmation slip packet (step S41) as occurs in the first embodiment, in this embodiment that packet is unconditionally forwarded to user terminal 11 (step S82). In other words, at order slip register 24 which receives the order confirmation slip, a decision is made by the same method as for the first embodiment as to whether that packet is valid or invalid, however order slip monitor 23 forwards that order confirmation slip to user terminal 11 regardless of the result of that decision. Accordingly, the instructions from order slip register 24 to order slip monitor 23 on whether forwarding of the order confirmation slip is required or not required are dispensed with in this embodiment.

Other aspects of the constitution and operations of the second embodiment are the same as for the first embodiment.

With this second embodiment an order slip with a destination IP address not registered in Web server IP table 28 and an order slip with a source IP address for which relationship with an appropriate subscriber line number cannot be ascertained at IP-subscriber table 27, that at order slip register 24 is not determined as being a valid order slip (and is therefore not stored in slip storage 29), will still be forwarded from user terminal 11 to Web server 15 and an order confirmation slip with a source IP address not registered in Web server IP table 28, an order confirmation slip with a destination IP address for which relationship with an appropriate subscriber line number cannot be ascertained at IP-subscriber table 27 and an order confirmation slip with no corresponding order slip, that at order slip register 24 is not determined as being a valid order confirmation slip (and is therefore not stored in slip storage 29), will still be forwarded from Web server 15 to user terminal 11. Accordingly, although a vexatious slip cannot be avoided, that is, an order confirmation slip unilaterally forwarded from Web server 15 to user terminal 11 when that user terminal has not placed an order, because the requisite order slip and order confirmation slip pair are not recorded, no economic disadvantage is caused to a genuine user terminal 11 user.

This embodiment is suitable where, in an environment in which an online shopping port number cannot be exclusively used only for the appropriate settlement system 20, only online transactions for which settlement system 20 acts in substitute for performance of settlement are monitored.

Third Embodiment

This third embodiment differs to the first embodiment in which user certification is performed based on conditions of the subscriber line, in that user certification is performed based on the calling telephone number. The configuration and operation of this embodiment will now be described focusing on the points of differentiation between this embodiment and the first embodiment.

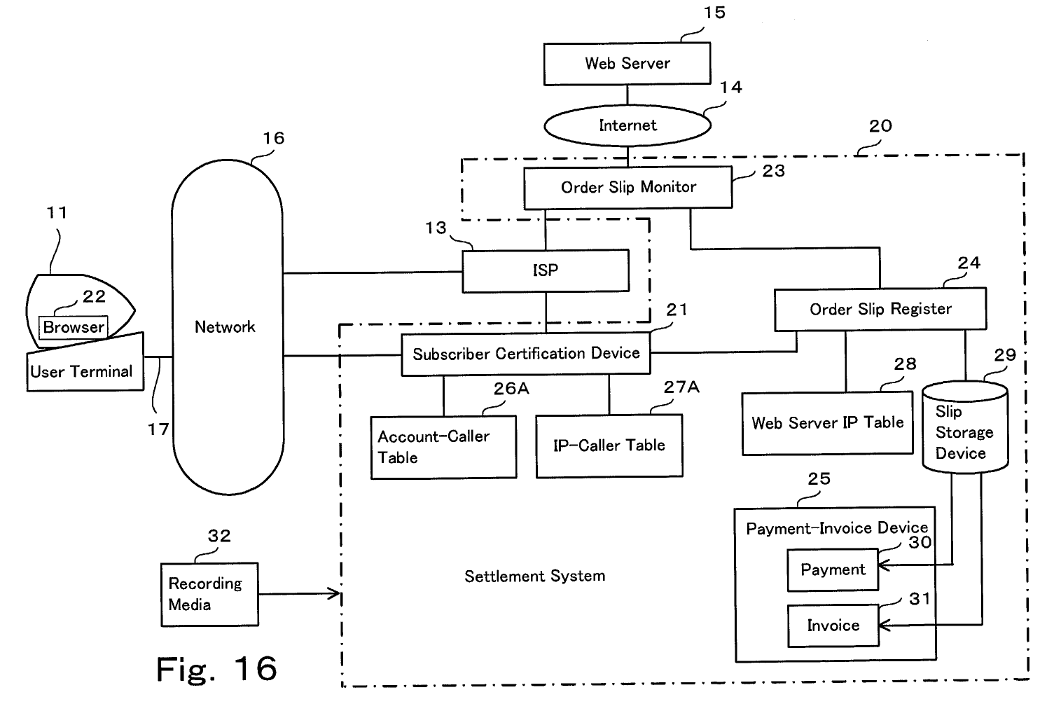

FIG. 16 is a block diagram of an online shopping system of this embodiment in which the same markings are applied to indicate the same parts as in FIG. 2, 26A is an account-caller table and 27A is an IP-caller table. For this embodiment, apart from an information processing device like a personal computer installed in a home for example, a mobile information terminal may also be used for user terminal 11. Further, it is possible for user terminal 11 to connect to ISP 13 via one or more subscriber switches forming network 16. For performing certification through a calling telephone number it is not necessary for subscriber certification device 21 to connect to a subscriber switch forming network 16.

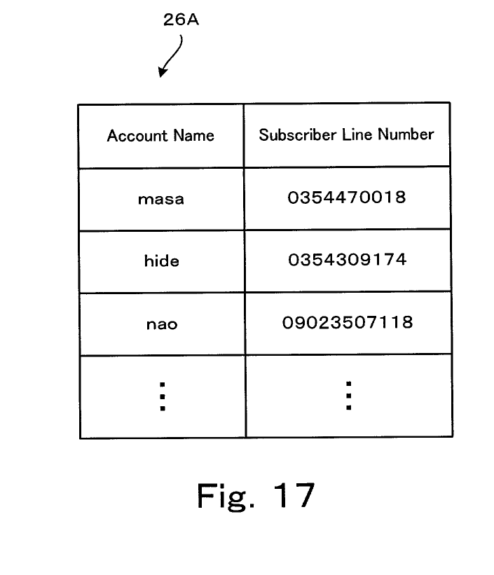

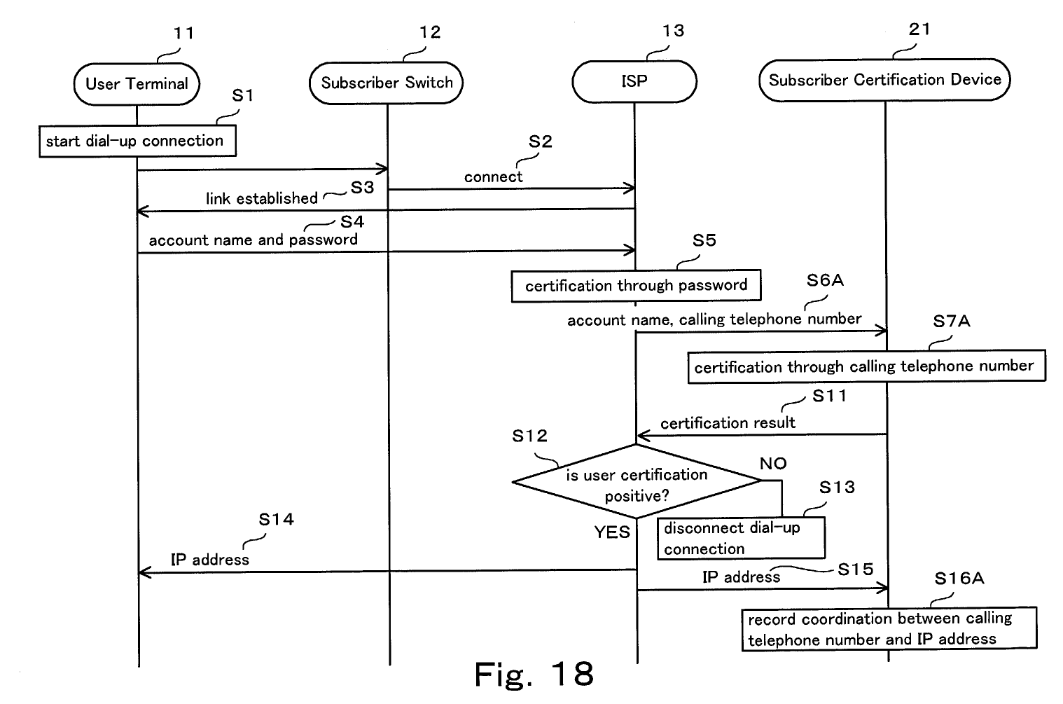

Subscriber certification device 21 certifies whether user terminal 11 with a dial-up connection to ISP 13 is a genuine user terminal or not based on the calling telephone number of user terminal 11. For this purpose, a list of the relationship between the account name allocated to each user terminal 11 by ISP 13 and the calling telephone number of the appropriate user terminal 11 as shown in FIG. 17, is recorded in advance in account-caller table 26A and this list is used to verify the user. Accordingly, the processes for the stage of connection from user terminal 11 to ISP 13 as they occur in this embodiment are as shown in FIG. 18. In other words, subscriber certification device 21 receives from ISP 13 the account name of the user terminal 11 and the calling telephone number of the user terminal 11 (step S6A), accesses account-caller table 26A using the account name to retrieve the appropriate calling telephone number, approves that user terminal as a genuine user terminal only when that retrieved calling telephone number agrees with the calling telephone number received from ISP 13 (step S7A) and notifies the result to ISP 13 (step S11). ISP 13 performs user certification with reference to the result of this certification by device 21.

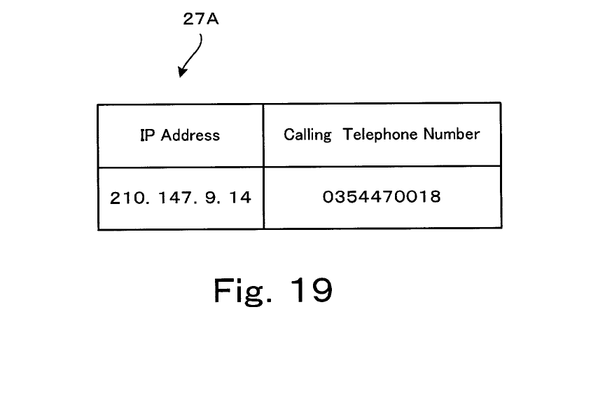

When user certification at ISP 13 is positive, subscriber certification device 21 receives the IP address dynamically allocated through ISP 13 for user terminal 11 (step S15) and registers the relationship between the IP address of user terminal 11 and the calling telephone number in IP-caller table 27A as shown in FIG. 19. In the same manner as the first embodiment this record remains while user terminal 11 is connected to ISP 13 and is extinguished when that connection is disconnected. The relationship between the genuine user terminal 11 IP address and calling telephone number registered in IPcaller table 27A is used for deciding the validity of an order slip and order confirmation slip at subsequent times when online shopping is performed. In other words, at step S28 as shown in FIG. 7, subscriber certification device 21 accesses IP-caller table 27A using the source IP address as the key, and order slip register 24 discards as invalid, an order slip for which the calling telephone number corresponding to the source IP address of that order slip is not registered in IP-caller table 27A (step S32). Further, when the other check is implemented and that order slip is determined as valid, the order slip is registered in slip storage 29 however, at such times, the calling telephone number is set in information on the order originator, area 295 of FIG. 10. Also, at step S46 of FIG. 8, subscriber certification device 21 accesses IP-caller table 27A using the destination IP address as the key, and register 24 discards as invalid, an order confirmation slip for which the calling telephone number for the destination IP address of the order confirmation slip is not registered in IP-caller table 27A (step S51).

Other aspects of the configuration and operations of the third embodiment are largely the same as for the first embodiment except that “subscriber line number” as it appears in the first embodiment is replaced by “calling telephone number” for this embodiment. Thus, this third example is a description of an example using a calling telephone number instead of a subscriber line number in the first embodiment but of course, an embodiment using calling telephone number instead of a subscriber line number in the second embodiment is also included within the present invention.

Because with this embodiment a calling telephone number is used to perform user certification, a dial-up connection can be coordinated from a mobile terminal without a subscriber line or for a subscriber not going through a local station (i.e. where a calling telephone number can be obtained but a subscriber line number cannot).

Fourth Embodiment

For the first through third embodiments the destination IP address of an order slip forwarded from user terminal 11 is set as the IP address of Web server 15, the destination IP address of an order confirmation slip forwarded from Web server 15 is set as user terminal 11 and the destination port number is set as an online shopping dedicated port number. Accordingly with those embodiments an order slip and order confirmation slip for reception between user terminal 11 and Web server 15 respectively are detected by order slip monitor 23 installed between ISP 13 and Internet 14. For the fourth embodiment however, the destination IP address of an order slip forwarded from user terminal 11 and the destination IP address of an order confirmation slip forwarded from Web server 15 are each set as an IP address for settlement system 20 and reception of an order slip and order confirmation slip between user terminal 11 and Web server 15 is performed using settlement system 20 as a relay point.

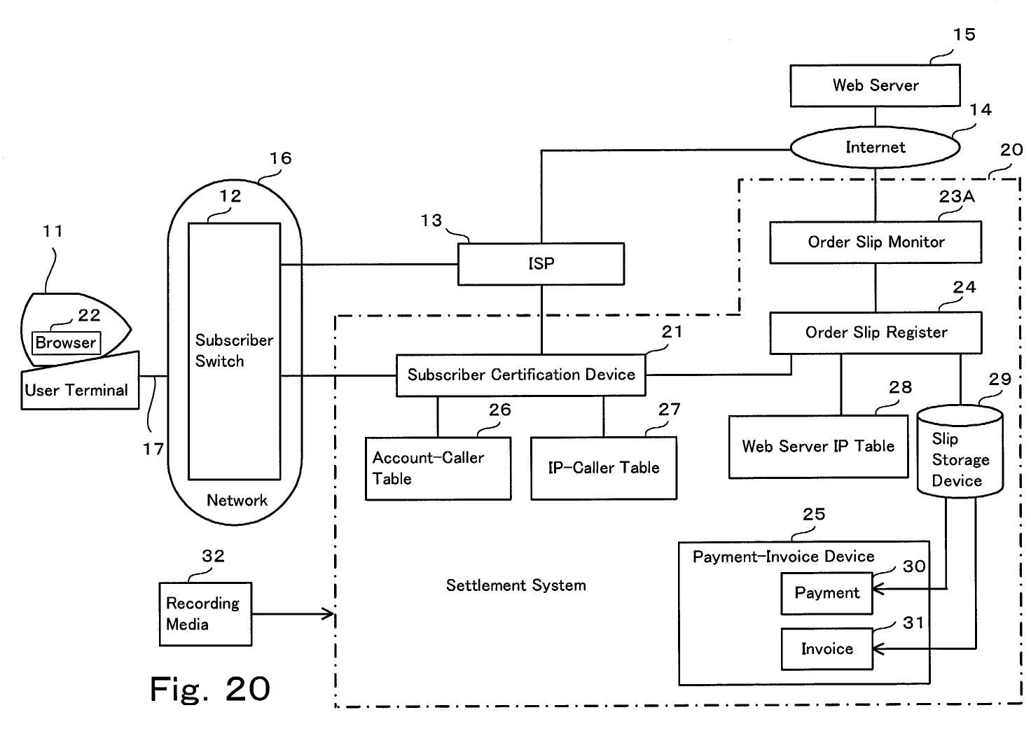

For this reason, with this fourth embodiment the IP address of Web server 15, the order recipient, is recorded in the order slip and settlement system 20, identifying this IP address, relays that order slip to Web server 15. In the same manner, the IP address of user terminal 11, the order originator, is recorded in the order confirmation slip and settlement system 20, identifying that IP address, relays that order confirmation slip to user terminal 11. An example of an online shopping system applying this embodiment is shown in FIG. 20.

In FIG. 20, order slip monitor 23A is a relay point, and in contrast to the first through third embodiments, order slip monitor 23A is not between ISP 13 and Internet 14 but is connected to Internet 14 as one server. Accordingly, ISP 13 is directly connected to Internet 14.

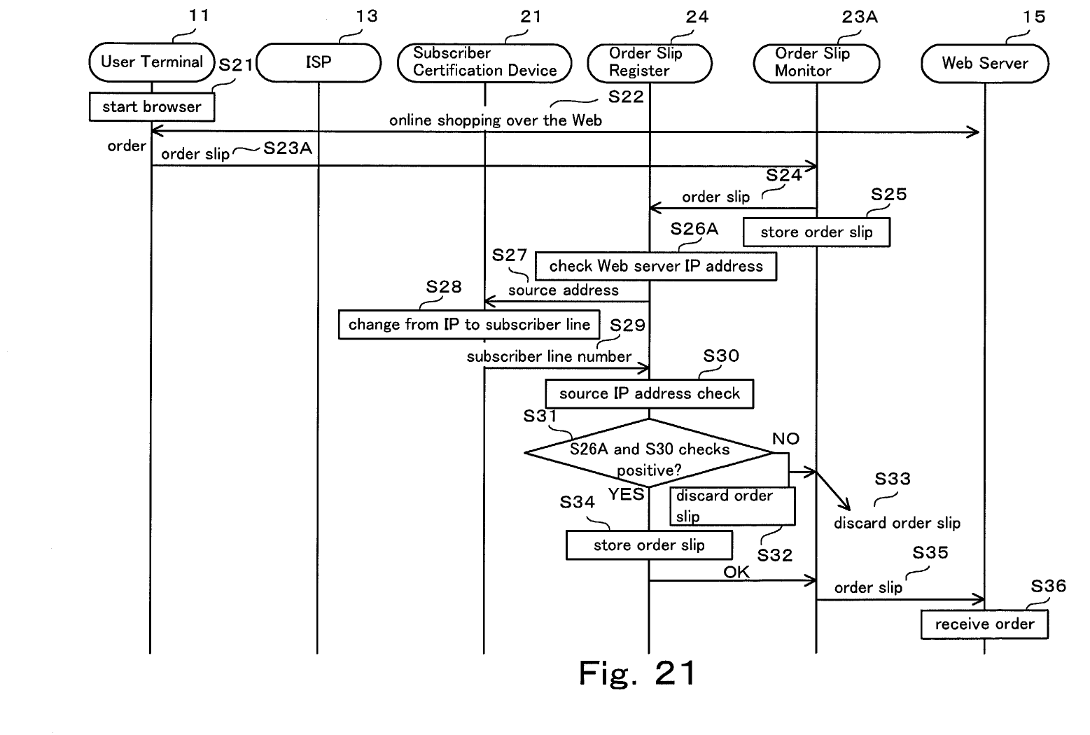

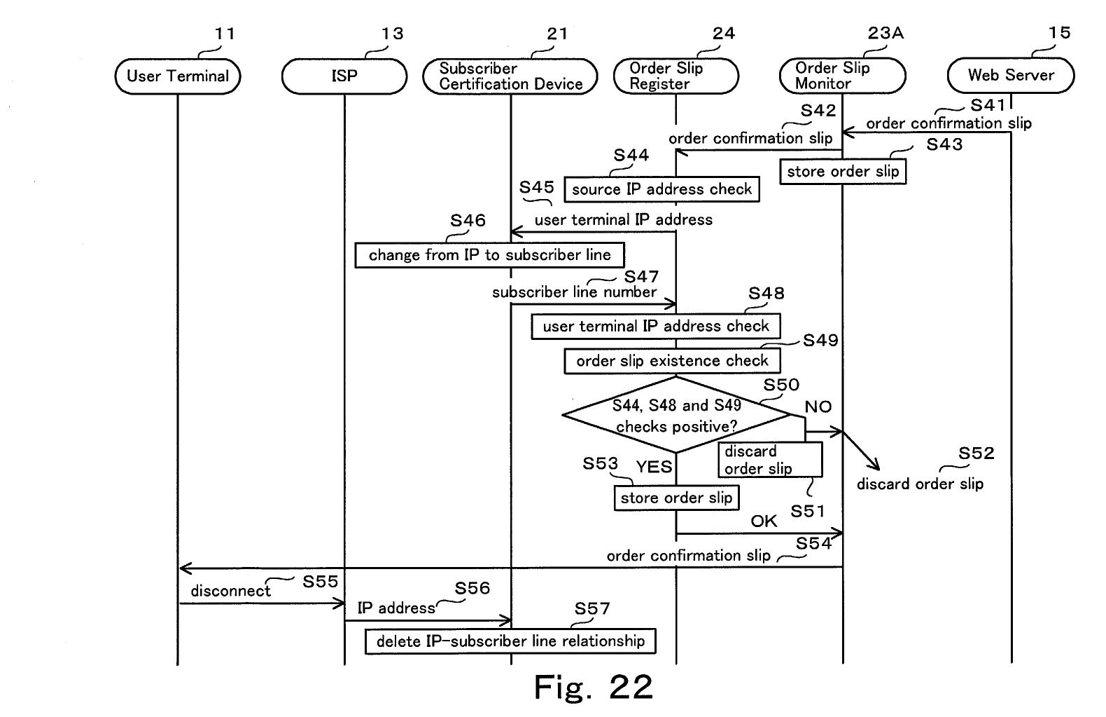

The flow at the online shopping stage between user terminal 11 and Web server 15 for this embodiment, is shown in FIGS. 21 and 22.

As a user of user terminal 11 orders goods, an order slip addressed to Web server 15 recording things like the details of the order is forwarded from browser 22 by TCP to order slip monitor 23A (step S23A). When ordering goods, that user sends an order slip recording things like the contents of the order from browser 22 by TCP addressed to Web server 15 (step S23). At this time, the destination IP address of the packet for the order slip is the IP address of order slip monitor 23A, the source IP address is set as the IP address of user terminal 11 and the IP address of Web server 15 is recorded in the order slip itself.

If order slip monitor 23A receives an order slip from user terminal 11, monitor 23A forwards that order slip to order slip register 24 (step S24) and because with this embodiment order slip monitor 23A is provided with firewall functionality, the order slip is temporarily stored at monitor 23A (step S25). If register 24 receives an order slip from monitor 23A register 24 performs the following two checks. Firstly, register 24 performs a Web server IP address check to determine whether or not the IP address for Web server 15 recorded in the order slip received is registered in Web server IP table 28 (step S26A) and then register 24 performs a source IP address check in the same manner as occurs for the first embodiment (step S30).

If the source IP address of the order slip packet is valid, corresponding to the subscriber line, moreover the IP address for the Web server in the order slip is a regular IP address registered in Web server IP table 28, order slip register 24 decides that order slip is valid, but any order slip not fulfilling those conditions is determined to be an irregular order slip (step S31). If there is an irregular order slip register 24 discards that order slip (step S32) and informs order slip monitor 23Athat that order slip is not to be forwarded. Monitor 23A then discards the temporarily stored packet for that order slip (step S33). When the order slip is valid however, register 24 records that order slip in order slip storage 29 (step S34) and informs monitor 23A that that order slip should be forwarded, at the same time, notifying monitor 23A of the IP address for Web server 15 recorded in the order slip. Monitor 23A rewrites the destination IP address of the packet for that temporarily stored order slip to become the IP address for Web server 15 thus notified and forwards the packet to Web server 15 (step S35). Web server 15 receives the order slip and performs procedures for receiving the order (step S36).

Operations performed at Web server 15 after receiving an order will now be described with reference to FIG. 22. Web server 15 upon receiving the order slip, forwards the order confirmation slip by TCP to user terminal 11 to notify user terminal 11 that the order slip has been properly received (step S41). The IP address of user terminal 11 is recorded in this order confirmation slip. The source IP address of the order confirmation slip packet is set as the IP address of Web server 15 and the destination IP address is set as the IP address of order slip monitor 23A.

If order slip monitor 23A receives the order confirmation slip from Web server 15, monitor 23A forwards that order confirmation slip to order slip register 24 (step S42). Further, with this embodiment, as order slip monitor 23A is provided with firewall functionality, the order confirmation slip is temporarily stored in order slip monitor 23A (step S43) and at the point at which the order confirmation slip is determined from order slip register 24 to be a valid order confirmation slip, the slip is forwarded to user terminal 11.

If order slip register 24 receives an order confirmation slip from order slip monitor 23A, register 24 performs the next 2 checks. Firstly, register 24 performs a source IP address check to determine whether or not the source IP address of the order confirmation slip it has received is registered in Web server IP table 28 (step S44). Next, register 24 performs a user terminal IP address check to determine whether or not the subscriber line number corresponding to the user terminal 11 IP address recorded in the order confirmation slip is registered in IP-subscriber table 27 (step S48). Register 24 forwards the IP address of user terminal 11 to subscriber certification device 21 for this check (step S45). Device 21 accesses IP-subscriber table 27 using that IP address (step S46) and returns the results to register 24 (step S47). If the result is positive the retrieved subscriber line number is returned. Next, register 24 performs a check to ascertain the existence of the order slip, to determine whether or not the order slip corresponding to the order confirmation slip is registered in slip storage 29 (step S49). This check is performed by accessing slip storage 29 that has a recording format as shown in FIG. 10, using the order slip number in a copy of the order slip included in the order confirmation slip to determine whether or not there is an entry in which the corresponding order slip is recorded.

If the IP address of user terminal 11 recorded in the order confirmation slip packet is valid, corresponding to the subscriber line number, the source IP address is a regular IP address registered in Web server IP table 28 and the corresponding order slip is present in order slip storage 29, order slip register 24 decides that order confirmation slip is valid, but any order confirmation slip not fulfilling those conditions is determined to be an irregular order confirmation slip (step S50). If there is an irregular order confirmation slip register 24 discards that order confirmation slip (step S51) and informs order slip monitor 23A that that order confirmation slip is not to be forwarded. Monitor 23A discards the temporarily stored packet for that order confirmation slip (step S52). When the order confirmation slip is valid however, register 24 records that order confirmation slip in the entry in order slip storage 29 in which the corresponding order slip is recorded (step S53) and informs monitor 23A that that order confirmation slip should be forwarded, at the same time, notifying monitor 23A of the user terminal 11 IP address recorded in the order confirmation slip. Monitor 23A rewrites the destination IP address for the temporarily stored order confirmation slip packet to become the IP address for user terminal 11 thus notified and forwards the packet to user terminal 11 (step S54). Browser 22 of user terminal 11 receives this order confirmation slip and displays it.

Other aspects of the constitution and operations of the fourth embodiment are largely the same as for the first embodiment. The fourth embodiment represents a variation in form of the first embodiment but of course, an embodiment providing a variation in form in the same manner for the second or third embodiments is also included within the present invention. As described, with the fourth embodiment an order slip to be forwarded from user terminal 11 to Web server 15 and an order confirmation slip to be forwarded from Web server 15 to user terminal 11 are temporarily forwarded to order slip monitor 23A of settlement system 20 from where those slips are relayed. Provided only that user terminal 11 and Web server 15 know the location of the relay point (the network address), this relay point can be set at any location on Internet 14.

Other Embodiments

The present invention has been described above with reference to several embodiments however this invention is not confined to the above described embodiments only and a variety of different additions are possible. For example, embodiments that could be likened to those described following would also be included within the present invention.

Embodiment with Order Slip Encrypted

In the embodiments described above an order slip and order confirmation slip flow over Internet 14 without being encrypted. In these cases, there may be concern of an invasion of privacy through data being intercepted by another person. At this point, encryption of an order slip and order confirmation slip is conceivable. This involves browser 22 and Web server 15 having encryption-decryption functionality, allowing the encryption and decryption of an order slip and order confirmation slip as they are sent or received. By providing the same kind of encryption functionality for settlement system 20 the contents of an order slip and order confirmation slip can be understood.

Embodiment with Limit Set on the Amount of Charges Paid in Substitution

Settlement system 20, like a credit card system, is a system for paying charges upfront in substitute and then collecting those charges at a subsequent date, therefore it is not desirable from the point of view of the communication common carrier, if any user purchases goods in excess of their capacity to pay. Accordingly, a limit can be set on the amount of charges which may be paid upfront in substitute for each user and a configuration introduced so that any order slip exceeding that limit is not accepted. This involves holding information on the monetary limit for each user and for the total amount used by each user each month in order slip register 24, so that when an order slip is forwarded from order slip monitor 23 or 23A, if the total amount used exceeds the limit, that order slip is discarded and a notification to that effect is issued to the user.

Electronic Mail Notification of Payment of Charges in Substitution

If damage arises to a user terminal or ISP network when Web shopping is performed, it may be unclear whether or not an order slip involved has been processed normally or discarded during the process. Providing for an e-mail to be sent from the communication common carrier to a user if the order is processed normally, enables the user concerned to be put at ease. This can be realized by providing for an e-mail to be sent to each user registered in advance when an order slip is correctly received at order slip register 24.

Multiple ISP Compatible Embodiment

In the embodiments described above only one ISP 13 is coordinated to operate with one subscriber certification device 21, however processing can be performed with one subscriber certification device operating in respect of multiple ISP. This can be realized by adding an ISP name to a record in a list coordinating an account name with a subscriber line number (or calling telephone number as the case may be), having the ISP name notified from the ISP in addition to the account name when a dial-up connection is established, and requiring discovery of a record indicating agreement between the account name and ISP name when referring the relationship between the account name and subscriber line number (or calling line number as the case may be). Where user certification is based on conditions of a subscriber line, when an inquiry is made to the subscriber switch, confirmation is made that the appropriate ISP is the point to which the subscriber line is connected, while in the case of certification made through a calling telephone number, confirmation is made on whether there is agreement with the calling telephone number discovered.

The present invention as described realizes the following.

A user can enjoy online shopping without fear of risks associated with his credit card number flowing over a network. The reason for this is that collection of charges for online shopping that should be paid by a user terminal to a Web server is performed in substitute by a communication common carrier of which that user terminal is a subscriber. Accordingly, online shopping is also enabled for a user who does not have a credit card.

A user can easily enjoy online shopping. The reason for this is that it is sufficient for an order slip to be forwarded to a Web server, and there is no need to perform special procedures requesting the sending of an invoice by making a telephone call as in the first conventional technology, to exchange e-mails with a purchasing agency service provider as in the second conventional technology or to send a payment transfer request e-mail as in the third conventional technology. The result is online shopping through very simple procedures. A Web shop can expand its customers without increasing the burden required for performance of settlement procedures to the same degree as when credit card settlement is used. The reason for this is that a purchase can be completed simply by changing the invoice recipient to a communication common carrier instead of a credit card company, and even a user who does not possess a credit card can become a customer.

A communication common carrier can prevent an irregular invoice from a Web shop. The reason for this is that as the communication common carrier acts as a substitute for collection of charges associated with a transaction for which the requisite pair of order slip and order confirmation slip are prepared, the communication common carrier can prevent an irregular invoice from a Web shop for a fictitious transaction. This is especially so because it is possible to effectively prevent any irregular transaction through a configuration wherein only a valid order slip and order confirmation slip are recorded. This is achieved through conducting a check on an order slip to determine whether there is correspondence between the source IP address for the order slip and the subscriber line number or calling telephone number of a user affirmed through user certification, or to determine whether the Web server that is the recipient of the order slip is a correctly registered Web server, and/or this can be achieved through conducting a check on an order confirmation slip to determine whether there is correspondence between the IP address of the user terminal that is the recipient of the order confirmation slip and the subscriber line number or calling telephone number of a user affirmed through user certification. Further, by preventing an invalid order slip or order confirmation slip from reaching its destination, firewall functionality can be provided to the settlement system.

What is claimed is:

1. An online shopping settlement method wherein both an order slip forwarded from a user terminal to a Web server providing online shopping services and an order confirmation slip for confirming receipt of said order slip forwarded from said Web server to said user terminal are detected by a communication common carrier that provides communication service to said user terminal and collects the price therefor as communication charges, acting as a substitute, in respect of transactions for which said requisite pair of order slip and order confirmation slip are prepared, to collect charges that should be paid by said user terminal to said Web server.

2. An online shopping settlement method that is a settlement method for an online shopping system comprising a user terminal, an Internet service provider connected to said user terminal via a network of a communication common carrier providing communication services to said user terminal and a Web server connected to said Internet service provider via the Internet providing online shopping services for said user terminal, which settlement method includes:
(a) a step for detecting an order slip forwarded from said user terminal to said Web server and the corresponding order confirmation slip for confirming receipt of said order slip forwarded from said Web server to said user terminal;
(b) a step for recording said order slip and order confirmation slip thus detected; and
(c) a step wherein said communication common carrier that provides a communication service to said user terminal and collects the price therefor as communication charges, acts as a substitute in respect of a transaction for which the requisite pair of order slip and order confirmation slip are prepared and which transaction is recorded, to collect charges that should be paid by said user terminal to said Web server.

3. An online shopping settlement method according to claim 2, which uses a port number for online shopping especially set for said order slip and order confirmation slip for sending and receiving said order slip and order confirmation slip between said user terminal and said Web server respectively and wherein, at said step (a), a packet among packets going out from said Internet service provider to the Internet which has an online shopping port number is detected as being said order slip and a packet among packets coming into said Internet service provider from the Internet which has an online shopping port number is detected as being said order confirmation slip.

4. An online shopping settlement method according to claim 2, which relays said order slip and said order confirmation slip using a relay point established in advance for facilitating the sending and receiving of those slips between said user terminal and Web server and wherein, at said step (a), said order slip and order confirmation slip are detected through said relay point.

5. An online shopping settlement method according to any of claim 3 or 4, which at said step (b) uses a Web server IP table holding a list of IP addresses of Web servers for which charges are collected in substitute and does not record an order slip among those order slips detected at said step (a) for which the IP address of the Web server that is the destination is not registered in said Web server IP table and does not record an order confirmation slip amongst those order confirmation slips detected at said step (a) for which the IP address of the Web server that is the sender is not registered in said Web server IP tab.

6. An online shopping settlement method according to any of claim 3 or 4 wherein is also included a step (d)
that establishes an account-subscriber table holding a list of the relationship between the account name allocated to said user terminal by said Internet service provider and the subscriber line number of said user terminal, that accesses said account-subscriber table using the account name of said user terminal that connected to the Internet service provider to retrieve the subscriber line number and then certifies said user terminal that connected to said Internet service provider through checking conditions of said subscriber line.

7. An online shopping settlement method according to claim 6, wherein while said user terminal is connected to said Internet service provider, the relationship between the IP address allocated to said user terminal from said Internet service provider and the subscriber line number is stored in an IP-subscriber table, which method at said step (b), does not record an order slip from among those order slips detected at said step (a) for which the subscriber line number corresponding to the source IP address is not registered in said IP-subscriber table, and does not record an order confirmation slip from among those order confirmation slips detected at said step (a) for which the subscriber line number corresponding to the IP address of the user terminal that is the destination is not registered in said IP-subscriber table.

8. An online shopping settlement method according to any of claim 3 or 4 wherein is also included a step (d)
that establishes an account-caller table holding a list of the relationship between the account name allocated to said user terminal by said Internet service provider and the calling telephone number of said user terminal, and certifies said user terminal connected to said Internet service provider through checking whether or not the combination of the account name of said user terminal connected to said Internet service provider and the calling telephone number is registered in said account-caller table.

9. An online shopping settlement method according to claim 8 wherein while said user terminal is connected to said Internet service provider, the relationship between the IP address allocated to said user terminal from said Internet service provider and the calling telephone number is stored in an IP-caller table, which method at said step (b), does not record an order slip from among those order slips detected at said step (a) for which the calling telephone number corresponding to the source IP address is not registered in said IP-caller table, and does not record an order confirmation slip from among those order confirmation slips detected at said step (a) for which the calling telephone number corresponding to the IP address of the user terminal that is the destination is not registered in said IP-caller table.

10. An online shopping settlement method according to any of claim 5, 7 or 9 wherein if at said step (b) an order slip is not recorded said order slip is not delivered to said Web server and if an order confirmation slip is not recorded said order confirmation slip is not delivered to said user terminal.

11. An online shopping settlement method according to any of claim 5,7 or 9 wherein regardless of whether at said step (b) an order slip is recorded or not recorded said order slip is delivered to said Web server and regardless of whether at said step (b) said order confirmation slip is recorded or not recorded said order confirmation slip is delivered to said user terminal.

12. An online shopping settlement method according to any of claim 3 or 4, that at said step (c) calculates the online shopping charges that should be collected from said user based on said order slip and order confirmation slip recorded at said step (b) and requests payment therefor together with communication charges when invoicing said user terminal for communication charges.

13. An online shopping settlement method according to any of claim 3 or 4, that at said step (c) calculates the online shopping charges that should be paid to said Web server based on said order slip and order confirmation slip recorded at said step (b) and pays those online shopping charges to said Web server.

14. An online shopping settlement system that provides a means for collecting charges in substitute, which means provides an order slip monitoring means for detecting an order slip forwarded from a user terminal to said Web server providing online shopping services and detecting the corresponding order confirmation slip forwarded from said Web server to said user terminal for confirming receipt of said order slip, provides an order slip recording means for recording an order slip and order confirmation slip detected by said order slip monitoring means, which means for collecting charges in substitute is for use by a communication common carrier that provides a communication service to said user terminal and collects the price therefor as communication charges, and which means for collecting charges in substitute acts as a substitute, in respect of a transaction for which the requisite pair of order slip and order confirmation slip are prepared and recorded in said order slip recording means, to collect charges that should be paid by said user terminal to said Web server.

15. An online shopping settlement system that is a settlement system of an online shopping system comprising a user terminal, an Internet service provider connected to said user terminal via a network of a communication common carrier providing communication services to said user terminal and a Web server connected to said Internet service provider via said Internet which server provides online shopping services to said user terminal, which settlement system includes:
an order slip monitoring means for detecting an order slip forwarded from said user terminal to said Web server and detecting the corresponding order confirmation slip forwarded from said Web server to said user terminal for confirming receipt of said order slip; and
an order slip recording means for recording said order slip and order confirmation slip detected by said order slip monitoring means; and
a settlement means for collecting charges in substitute that is a means for use by said communication common carrier which means acts as a substitute in respect of a transaction for which said requisite pair of order slip and order confirmation slip are prepared and recorded in said order slip recording means, to collect charges that should be paid by said user terminal to said Web server.

16. An online shopping settlement system according to claim 15 wherein the configuration is such that a port number for online shopping especially set for said order slip and order confirmation slip is used, facilitating the sending and receiving of said order slip and order confirmation slip between said user terminal and said Web server, and wherein said order slip monitoring means provides a means for detecting those packets among packets going out from said Internet service provider to the Internet which have an online shopping port number as being an order slip and detecting those packets among packets coming into said Internet service provider from the Internet which have an online shopping port number as being an order confirmation slip.

17. An online shopping settlement system according to claim 15 wherein the configuration facilitates relaying said order slip and said order confirmation slip using a relay point established in advance, for sending and receiving of those slips between said user terminal and said Web server, and wherein said order slip monitoring means detects said order slip and order confirmation slip through said relay point.

18. An online shopping settlement system according to any of claim 16 or 17 wherein said order slip recording means provides a Web server IP table holding a list of IP addresses of Web servers for which charges are collected in substitute, which means is configured so as not to record an order slip among those order slips detected by said order slip monitoring means for which the IP address of said Web server that is the destination is not registered in said Web server IP table and not to record an order confirmation slip amongst those order confirmation slips detected by said order slip monitoring means for which the source IP address is not registered in said Web server IP table.

19. An online shopping settlement system according to any of claim 16 or 17 that provides an account-subscriber table holding a list of the relationship between the account name allocated to said user terminal by said Internet service provider and the subscriber line number of said user terminal, and that provides a subscriber certification means that receives from said Internet service provider the account name of said user terminal that connected to said Internet service provider, accesses said account-subscriber table and retrieves the appropriate subscriber line number and through checking the condition of that subscriber line, certifies said user terminal connected to said Internet service provider.

20. An online shopping settlement system according to claim 19 wherein said subscriber certification means provides an IP-subscriber table for storing the relationship between the IP address allocated to said user terminal from said Internet service provider and the subscriber line number while said user terminal is connected to said Internet service provider,
and wherein said order slip recording means is configured so as not to record an order slip from among those order slips detected by said order slip monitoring means for which the subscriber line number corresponding to the source IP address is not registered in said IP-subscriber table, and so as not to record an order confirmation slip from among those order confirmation slips detected by said order slip monitoring means for which the subscriber line number corresponding to the IP address of the user terminal that is the destination is not registered in said IP-subscriber table.

21. An online shopping settlement system according to any of claim 16 or 17 that provides an account-caller table holding a list of the relationship between the account name allocated to said user terminal by said Internet service provider and the calling telephone number of said user terminal, and that provides a subscriber certification means that receives from said Internet service provider, the account name of said user terminal that connected to said Internet service provider and the calling telephone number, and through checking whether or not the combination of the account name of said user terminal connected to said Internet service provider and the calling telephone number is registered in said account-caller table, certifies said user terminal that connected to said Internet service provider.

22. An online shopping settlement system according to claim 21 wherein said subscriber certification means provides an IP-caller table that stores the relationship between the IP address allocated to said user terminal from said Internet service provider and the calling telephone number while said user terminal is connected to said Internet service provider,
and wherein said order slip recording means is configured so as not to record an order slip from among those order slips detected by said order slip monitoring means for which the calling telephone number corresponding to the source IP address is not registered in said IP-caller table, and so as not to record an order confirmation slip from among those order confirmation slips detected by said order slip monitoring means for which the calling telephone number corresponding to the IP address of said user terminal that is the destination is not registered in said IP-caller table.

23. An online shopping settlement system according to any of claim 18, 20 or 22 configured such that if said order slip recording means does not record an order slip said order slip monitoring means does not deliver said order slip to said Web server and if said order slip recording means does not record an order confirmation slip, said order slip monitoring means does not deliver said order confirmation slip to said user terminal.

24. An online shopping settlement system according to any of claim 18, 20 or 22 configured such that regardless of whether an order slip and order confirmation slip are recorded or not recorded through said order slip recording means, said order slip monitoring means delivers said order slip to said Web server and said order confirmation slip to said user terminal.

25. An online shopping settlement system according to any of claim 16 or 17 wherein said settlement means provides a means for calculating the online shopping charges that should be collected from said user based on said order slip and order confirmation slip recorded by said order slip recording means and requests payment therefor together with communication charges when invoicing said user terminal for communication charges.

26. An online shopping settlement system according to any of claim 16 or 17 wherein said settlement means provides a means for calculating the online shopping charges that should be paid to said Web server based on said order slip and order confirmation slip recorded by said order slip recording means and pays those online shopping charges to said Web server.

27. An online shopping settlement program operating a computer forming a settlement system of an online shopping system that includes a user terminal, an Internet service provider connected to said user terminal via a network of a communication common carrier providing communication services to said user terminal and a Web server connected to said Internet service provider via the Internet which server provides online shopping services to said user terminal, such that said computer functions as:
an order slip monitoring means for detecting an order slip forwarded from said user terminal to said Web server and detecting the corresponding order confirmation slip forwarded from said Web server to said user terminal for confirming receipt of said order slip;
an order slip recording means for recording said order slip and order confirmation slip detected by said order slip monitoring means; and
a settlement means for collecting charges in substitute that is a means for use by said communication common carrier which means acts as a substitute in respect of a transaction for which the requisite pair of order slip and order confirmation slip are prepared and recorded in said order slip recording means, to collect charges that should be paid by said user terminal to said Web server.

28. An online shopping settlement program according to claim 27 facilitating a configuration wherein a port number for online shopping especially set for said order slip and order confirmation slip is used, facilitating the sending and receiving of said order slip and order confirmation slip between said user terminal and said Web server,
and facilitating said order slip monitoring means providing a means for detecting those packets among packets going out from said Internet service provider to said Internet which have an online shopping port number as being an order slip and detecting those packets among packets coming into said Internet service provider from said Internet which have an online shopping port number as being an order confirmation slip.

29. An online shopping settlement program according to claim 27 facilitating a configuration wherein said order slip and said order confirmation slip are relayed using a relay point established in advance, for sending and receiving of those slips between said user terminal and said Web server, and facilitating said order slip monitoring means detecting said order slip and order confirmation slip through said relay point.

30. An online shopping settlement program according to claim 28 or 29 facilitating operations such that said order slip recording means provides a Web server IP table holding a list of IP addresses of Web servers for which charges are collected in substitute, and facilitating a configuration wherein said means operates so as not to record an order slip among those order slips detected by said order slip monitoring means for which the IP address of said Web server that is the destination is not registered in said Web server IP table and so as not to record an order confirmation slip amongst those order confirmation slips detected by said order slip monitoring means for which the source IP address is not registered in said Web server IP table.

31. An online shopping settlement program according to any of claim 28 or 29 that operates said computer such that said computer provides an account-subscriber table holding a list of the relationship between the account name allocated to said user terminal by said Internet service provider and the subscriber line number of said user terminal, and such that said computer functions as a subscriber certification means that receives from said Internet service provider the account name of said user terminal that connected to said Internet service provider, accesses said account-subscriber table and retrieves said appropriate subscriber line number and through checking the condition of that subscriber line, certifies said user terminal connected to said Internet service provider.

32. An online shopping settlement program according to claim 31 facilitating operations such that said subscriber certification means provides an IP-subscriber table that stores the relationship between the IP address allocated to said user terminal from said Internet service provider and said subscriber line number while said user terminal is connected to said Internet service provider,
and facilitating operations such that said order slip recording means does not record an order slip from among those order slips detected by said order slip monitoring means for which the subscriber line number corresponding to the source IP address is not registered in said IP-subscriber table and does not record an order confirmation slip from among those order confirmation slips detected by said order slip monitoring means for which the subscriber line number corresponding to the IP address of said user terminal that is the destination is not registered in said IP-subscriber table.

33. An online shopping settlement program according to any of claim 28 or 29 that operates said computer such that said computer provides an account-caller table holding a list of the relationship between the account name allocated to said user terminal by said Internet service provider and the calling telephone number of said user terminal, and such that said computer functions as a subscriber certification means that receives from said Internet service provider, the account name of said user terminal that connected to said Internet service provider and the calling telephone number, and through checking whether or not the combination of the account name of said user terminal connected to said Internet service provider and the calling telephone number is registered in said account-caller table, certifies said user terminal that connected to said Internet service provider.

34. An online shopping settlement program according to claim 33 facilitating operations such that said subscriber certification means provides an IP-caller table that stores the relationship between the IP address allocated to said user terminal from said Internet service provider and the calling telephone number while said user terminal is connected to said Internet service provider,
and facilitating operations such that said order slip recording means does not record an order slip from among those order slips detected by said order slip monitoring means for which the calling telephone number corresponding to the source IP address is not registered in said IP-caller table, and does not record an order confirmation slip from among those order confirmation slips detected by said order slip monitoring means for which the calling telephone number corresponding to the IP address of said user terminal that is the destination is not registered in said IP-caller table.

35. An online shopping settlement program according to any of claim 30, 32 or 34 facilitating operations such that if said order slip recording means does not record an order slip said order slip monitoring means does not deliver said order slip to said Web server and if said order slip recording means does not record an order confirmation slip, said order slip monitoring means does not deliver said order confirmation slip to said user terminal.

36. An online shopping program according to any of claim 30, 32 or 34 facilitating operations such that regardless of whether an order slip and/or order confirmation slip are recorded or not recorded through said order slip recording means, said order slip monitoring means delivers said order slip to said Web server and said order confirmation slip to said user terminal.

37. An online shopping settlement program according to any of claim 30, 32 or 34 facilitating operations such that said settlement means provides a means for calculating the online shopping charges that should be collected from said user based on said order slip and order confirmation slip recorded by said order slip recording means and requests payment therefor together with communication charges when invoicing said user terminal for communication charges.

38. An online shopping settlement program according to any of claim 28 or 29 facilitating operations such that said settlement means provides a means for calculating the online shopping charges that should be paid to said Web server based on said order slip and order confirmation slip recorded by said order slip recording means and pays those online shopping charges to said Web server.
